(19) United States
(12) Patent Application Publication
(10) Pub. No.: US 2002/0161630 A1
(43) Pub. Date: Oct. 31, 2002

(54) Loyalty reward program for reducing the balance of a loan obligation

(75) Inventors: K. Jon Kern, Franktown, CO (US); Joseph Bird, Highlands Ranch, CO (US); Brooke Hartman, Parker, CO (US)

Correspondence Address: Reed R. Heimbecher, Dorsey & Whitney LLP, Republic Plaza Bldg., Suite 4700, 370 Seventeenth Street, Denver, CO, 80202-5647, US, heimbecher.reed@dorseylaw.com, 303-629-3400

(73) Assignee: Nelnet Loan Services, Inc., Aurora, 80014-2906 (US)

(21) Appl. No.: 09/677,401

(22) Filed: Sep. 29, 2000

Related U.S. Application Data
(60) Provisional application No. 60/216,622, filed on Jul. 7, 2000.

(51) Int. Cl. G06F 17/60

(52) U.S. Cl. 705/14; 705/38

(57) ABSTRACT

### Abstract of Disclosure

A method and apparatus for reducing the balance of a consumer or educational loan obligation using a loyalty reward program is disclosed. Loan obligors can reduce the balances of their loan obligations by purchasing consumer goods and services that they would normally purchase. The method essentially comprises the steps of (a) establishing a site on a global computer network; (b) recognizing at least certain users of the site; (c) directing the recognized users to merchants; (d) enabling accumulation of loyalty points by the recognized users based upon purchases from the merchants; (e) monitoring the purchases by the recognized users from the merchants; (f) tracking the accumulated loyalty points; and (g) permitting selective redemption of the accumulated loyalty points. Users of the site are recognized by requiring them to provide initial registration information. Accumulated loyalty points may be categorized with a status of "pending" or a status of "earned." Selective redemption of the accumulated loyalty points includes selective application of earned loyalty points to a loan of a recognized user to permit repayment of the loan, or selective transfer of earned loyalty points from one recognized user to another recognized user. Information about accumulated, redeemed, and transferred loyalty points may be displayed to a recognized user.

### Cross Reference to Related Applications

This application claims priority to United States Provisional Application Serial No. 60/216,622, filed 7 July 2000 (the '622 application). The '622 application is hereby incorporated by reference as though fully set forth herein.

### Background of Invention

a. Field of the Invention

The instant invention is directed toward a method and apparatus for reducing the balance of a loan obligation. More specifically, it relates to a method and apparatus for reducing the balance of a loan obligation using a loyalty reward program.

b. Background Art

Loyalty reward programs are not new. Existing programs include frequent flyer programs introduced years ago by the airlines, frequent filler programs more recently introduced by gas stations, stamp redemption programs that have been popular for many years, gift reward programs offered by cable companies and other commercial enterprises, and cash-back bonus programs offered by credit card companies. Some of these existing programs include tiered structures where higher levels of consumption or spending result in proportionally higher rewards or reward potential.

Despite the lengthy existence of such reward programs, few reward programs have been available in the area of consumer and educational loans. Some financial institutions offer interest rate discounts if, for example, borrowers have their paychecks directly deposited with the financial institution, or if borrowers authorize the financial institution to automatically withdraw loan payments from the borrowers' accounts. There remains a need, however, for a system that directly benefits borrowers by reducing the balances of their consumer and educational loan obligations using a loyalty reward program.

### Summary of Invention

The present invention fulfills the need for a system to reduce the balance of a consumer or educational loan obligation using a loyalty reward program. It is, therefore, an object of the disclosed invention to provide an improved method and apparatus for reducing the balance of a loan obligation using a loyalty reward program. In its most preferred form, the present invention permits loan obligors to reduce the balances of their loan obligations simply by purchasing consumer goods and services that they would normally purchase.

In one preferred form, the method of the present invention comprises the steps of (a) establishing a site on a global computer network; (b) recognizing at least certain users of the site; (c) directing the recognized users to merchants; (d) enabling accumulation of loyalty points by the recognized users based upon purchases from the merchants; (e) monitoring the purchases by the recognized users from the merchants; (f) tracking the accumulated loyalty points; and (g) permitting selective redemption of the accumulated loyalty points.

In another preferred form, the invention comprises a method of facilitating repayment of a loan obligation by (a) establishing a site on a global computer network; (b) recognizing at least certain users of the site by requiring the certain users to provide initial registration information; (c) directing the recognized users to predetermined merchants; (d) enabling accumulation of loyalty points by the recognized users based upon purchases from the predetermined merchants; (e) monitoring the purchases by the recognized users from the predetermined merchants; and (f) tracking the accumulated loyalty points.

In yet another preferred form, the invention comprises a method of facilitating repayment of a loan obligation by (a) establishing a site on a global computer network; (b) recognizing at least certain users of the site by requiring the certain users to provide initial registration information, wherein the recognized users include a first recognized user and a second recognized user; (c) requiring the first recognized user to provide additional registration information; (d) directing the recognized users to predetermined merchants; (e) enabling accumulation of loyalty points by the recognized users based upon purchases from the predetermined merchants; (f) monitoring the purchases by the recognized users from the predetermined merchants; (g) tracking the accumulated loyalty points; and (h) permitting selective application of the accumulated loyalty points to at least one loan of the first recognized user.

In still another preferred form, the invention comprises a method of facilitating repayment of a loan obligation by (a) establishing a site on a global computer network; (b) recognizing at least certain users of the site by requiring the certain users to provide initial registration information, wherein the recognized users include a first recognized user and a second recognized user; (c) requiring the first recognized user to provide additional registration information; (d) directing the recognized users to merchants; (e) enabling accumulation of loyalty points by the recognized users based upon purchases from the merchants; (f) monitoring the purchases by the recognized users from the merchants; (g) tracking the accumulated loyalty points; and (h) displaying information about the accumulated loyalty points to the first recognized user.

In another preferred form, the invention comprises a method of facilitating repayment of a loan obligation by (a) establishing a site on a global computer network; (b) recognizing at least certain users of the site by requiring the certain users to provide initial registration information, wherein the recognized users include a first recognized user and a second recognized user; (c) requiring the first recognized user to provide additional registration information; (d) directing the recognized users to predetermined merchants; (e) enabling accumulation of loyalty points by the recognized users based upon purchases from the predetermined merchants; (f) monitoring the purchases by the recognized users from the predetermined merchants; (g) tracking the accumulated loyalty points; (h) categorizing a first number of the accumulated loyalty points of the first recognized user with a first status of "pending," and categorizing a second number of the accumulated loyalty points of the first recognized user with a second status of "earned"; (i) permitting the first recognized user to selectively redeem the accumulated loyalty points having the second status in a first redemption amount no greater than the second number of the accumulated loyalty points, wherein the first recognized user selectively redeems the accumulated loyalty points in one of the following two ways: (1) by applying the selectively redeemed loyalty points to an outstanding balance of a loan obligation of the first recognized user to permit repayment of the loan obligation using the applied loyalty points; and (2) by transferring the selectively redeemed loyalty points to the second recognized user; and (j) displaying loyalty points information to the first recognized user, wherein the displayed information includes the first number, the second number, and the first redemption amount.

In yet another preferred form, the invention comprises a method of facilitating repayment of a loan obligation by (a) establishing a site on a global computer network; (b) recognizing at least certain users of the site; (c) directing the recognized users to predetermined merchants; (d) enabling accumulation of loyalty points based upon purchases from the predetermined merchants; (e) monitoring the purchases by the recognized users from the predetermined merchants; (f) tracking the accumulated loyalty points; and (g) permitting selective repayment of the loan obligation based upon discretionary redemption of the accumulated loyalty points.

### Brief Description of Drawings

Fig. 1 is a highly schematic overview of a possible system for carrying out the present invention;

Fig. 2 is a first possible opening screen shot at a site on a global computer network for carrying out the method of the present invention;

Fig. 3 is similar to Fig. 2, but it is a second possible opening screen shot;

Fig. 4 is a screen shot of a possible screen for downloading music from the site;

Fig. 5 is a screen shot of a possible screen at the site for finding information about concerts;

Fig. 6 is a screen shot of a possible screen at the site for obtaining movie reviews;

Figs. 7 and 8 are an alternative means for navigating around the site;

Fig. 9 is a screen shot of a possible screen at the site for acquiring news and information concerning a particular college campus;

Fig. 10 is a screen shot of a possible screen at the site for conducting scholarship research;

Fig. 11 is a screen shot of a possible screen at the site for calculating potential college financial aid requirements;

Fig. 12 is a screen shot of a possible screen at the site for researching career information;

Fig. 13 is a screen shot of a possible screen at the site for acquiring test preparation information;

Fig. 14 is a screen shot of a possible screen at the site for researching colleges;

Fig. 15 is a screen shot of a possible screen at the site for booking travel and hotel arrangements;

Fig. 16 is a flowchart of the overall loyalty reward program according to the present invention;

Fig. 17 is a flowchart of the process for accumulating and tracking loyalty points according to the present invention;

Fig. 18 is a flowchart for obtaining access to view accounts;

Fig. 19 is a flowchart of the process according to the present invention for applying loyalty points;

Fig. 20 is a flowchart for determining whether an amount of loyalty points to be redeemed is a valid amount;

Fig. 21 is an overall flowchart of the process for updating loan balances;

Fig. 22 is a flowchart concerning the generation of various financial accounting reports;

Fig. 23 is a sample nightly report concerning loyalty points applied to loans being serviced by other than the primary loan servicer;

Fig. 24 is a sample nightly report displaying loyalty points applied to loans being serviced by the primary loan servicer;

Fig. 25 is a sample monthly report displaying loyalty points earned from various merchants;

Fig. 26 is a flowchart of the overall process for transferring loyalty points from one registered member to another registered member;

Fig. 27 is a screen shot of a possible screen for initially registering members;

Fig. 28 is a screen shot of a possible screen for initiating purchasing that will accumulate loyalty points;

Figs. 29 and 30 are screen shots of possible screens for narrowing a list of merchants by one or more categories;

Fig. 31 is a screen shot of a possible screen for alphabetically locating a particular merchant;

Fig. 32 is a screen shot of a sample merchant screen;

Fig. 33 is a screen shot of a sample screen depicting the available merchants under a particular selected category, in this case "Books and Textbooks";

Fig. 34 is similar to Fig. 33, but is a screen shot depicting available merchants under the category "Beauty";

Fig. 35 is a screen shot of a sample screen for purchasing textbooks from a preferred textbook provider;

Fig. 36 is a screen shot of a sample screen where the user's browser has been pointed to the preferred textbook provider's site on the global computer network;

Fig. 37 is a screen shot of a sample initial log-in screen at the site;

Fig. 38 is a screen shot of a sample summary screen depicting loyalty points accumulated by a registered member;

Fig. 39 is a screen shot of a sample screen depicting loyalty points accumulated by a registered member who has at least twenty-five earned loyalty points;

Fig. 40 is a screen shot of a sample screen providing more detailed account activity information;

Figs. 41A and 41B together comprise a screen shot of a sample full registration form required to view loan information at the site;

Fig. 42 is a screen shot of a sample screen depicting the student loan account information for a registered user having no loans being serviced by the primary loan servicer and insufficient earned loyalty points to apply them to a specified loan being serviced by a secondary loan servicer;

Fig. 43 is similar to Fig. 42, but displays the student loan account information for a registered user having three loans being serviced by the primary loan servicer and sufficient earned loyalty points that the registered member may apply a selected amount of loyalty points to reduce the balance remaining on a loan obligation;

Fig. 44 is a screen shot of a sample screen for selecting an available secondary loan servicer or commencing the process of entering information about an initially unavailable secondary loan servicer;

Fig. 45 is a screen shot of a sample follow-on screen to that depicted in Fig. 44 for entering the account number for a selected loan obligation;

Fig. 46 is a screen shot of a sample follow-on screen to that depicted in Fig. 45 for entering the amount of earned loyalty points to be applied to a selected loan obligation;

Fig. 47 is a screen shot of a screen similar to Fig. 40 but showing the payment made according to the process represented by Figs. 43-46;

Fig. 48 is a screen shot depicting a sample screen when a user tried to transfer loyalty points before having earned loyalty points;

Fig. 49 is a screen shot of a sample screen for specifying a registered member to whom loyalty points are to be transferred, and the amount of loyalty points to be transferred;

Fig. 50 is a screen shot of a sample screen when a registered member attempts to transfer loyalty points to an unrecognized person; and

Fig. 51 is a screen shot of a sample screen that may be used when a registered member attempts to transfer more loyalty points than are currently available for that member.

### Detailed Description

As discussed further below, the present invention involves both a method of reducing the balance of a loan obligation using a loyalty reward program, and an apparatus for carrying out the method. In the most preferred embodiment of the present invention, a primary loan servicer (e.g., UNIPAC Service Corporation, a Nebraska Corporation) has a site on a global computer network (e.g., a site on the World Wide Web portion of the Internet) that facilitates the method and apparatus according to the present invention. The invention permits repayment of loan obligations via the loyalty reward program whether the loan is being serviced by the primary loan servicer or a secondary loan servicer.

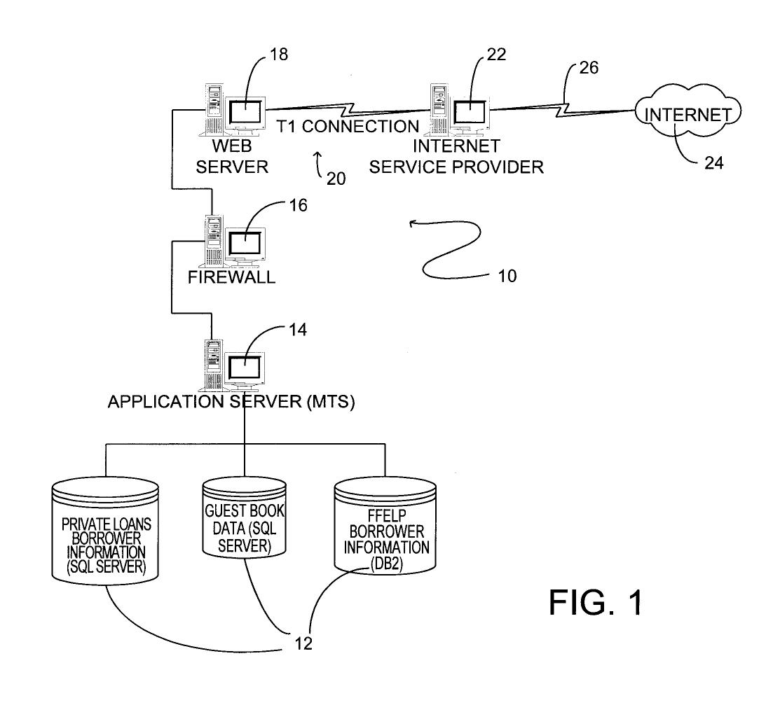

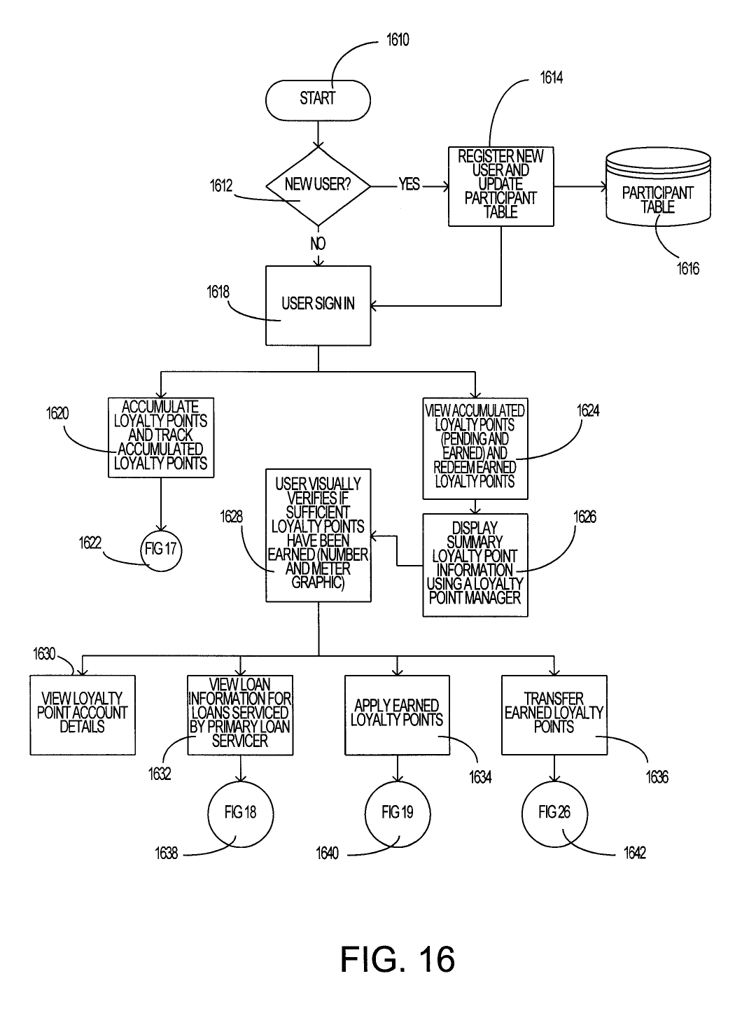

Fig. 1 is a highly schematic overview of the apparatus or system 10 according to the present invention, and Fig. 16 is a flowchart of the overall method according to the present invention. Referring to Fig. 1, the system 10 comprises a plurality of storage devices 12 for electronically storing information used by the system. An application server 14 retrieves and manipulates information from the storage devices 12 and exchanges information through a firewall 16 with a Web server 18. The Web server 18, in turn, exchanges information, preferably through a T1 connection 20, with an Internet Service Provider (ISP) 22. The ISP 22 exchanges information with end users over the Internet 24 via another connection 26.

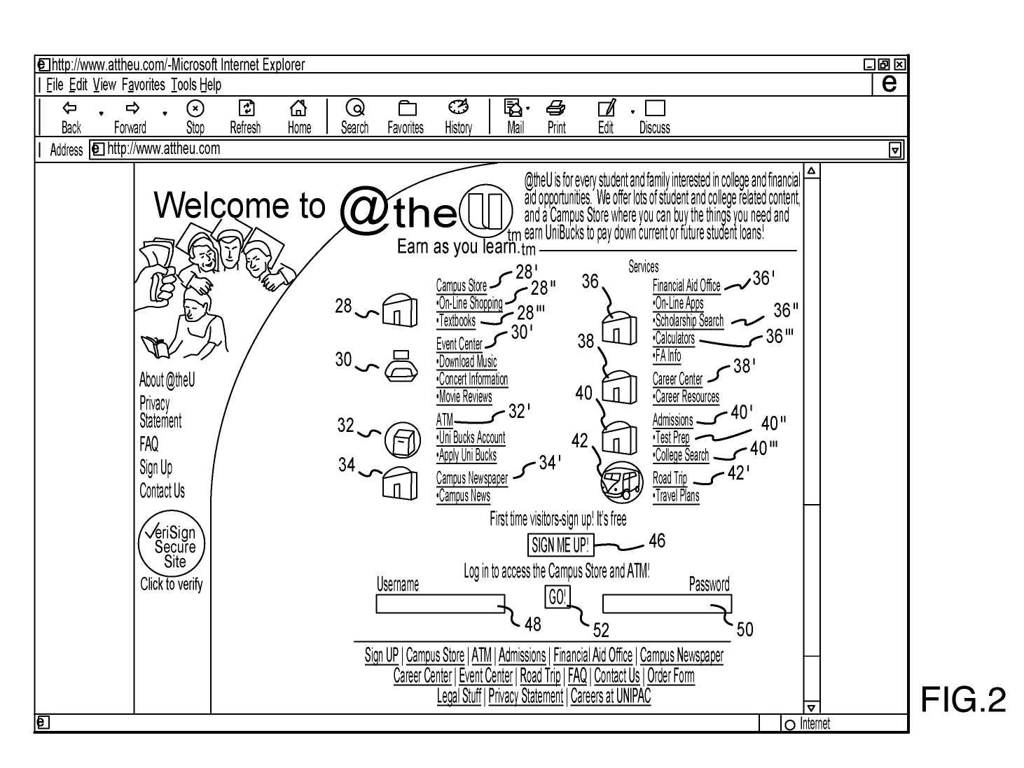

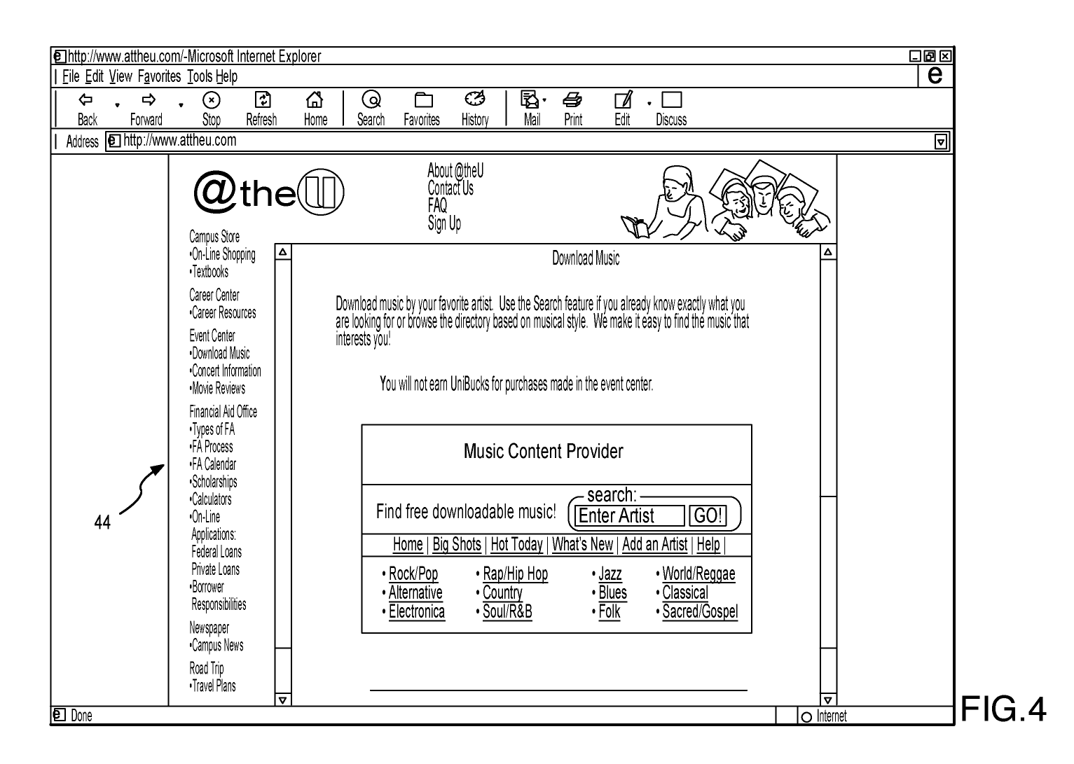

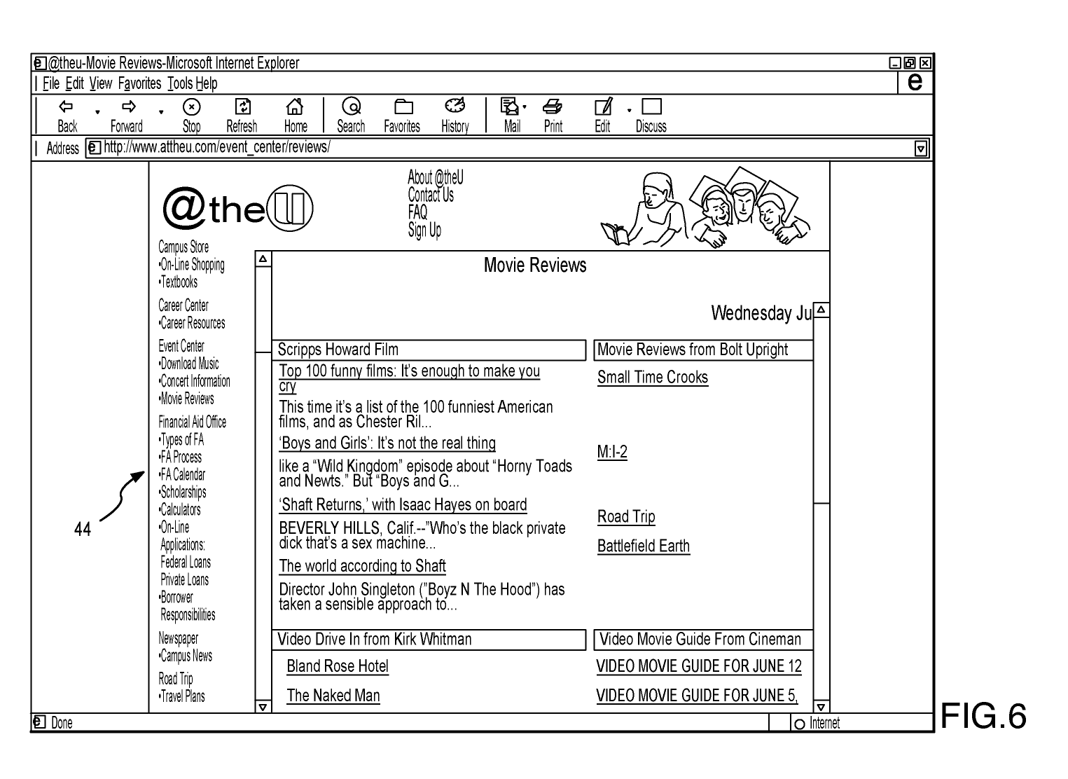

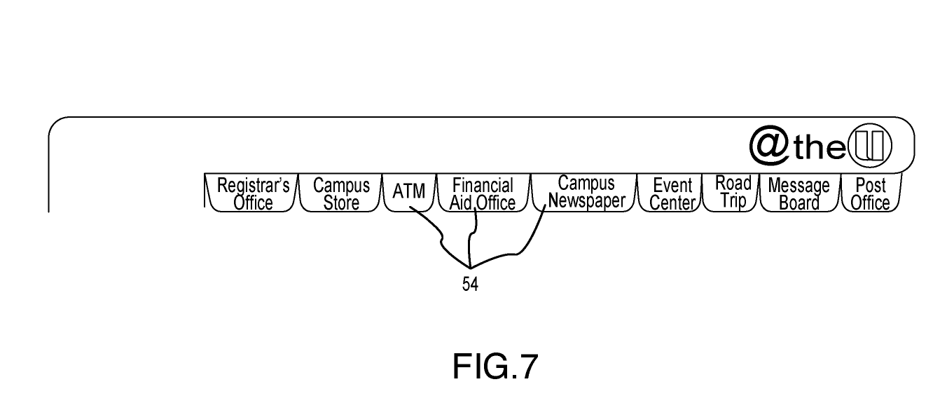

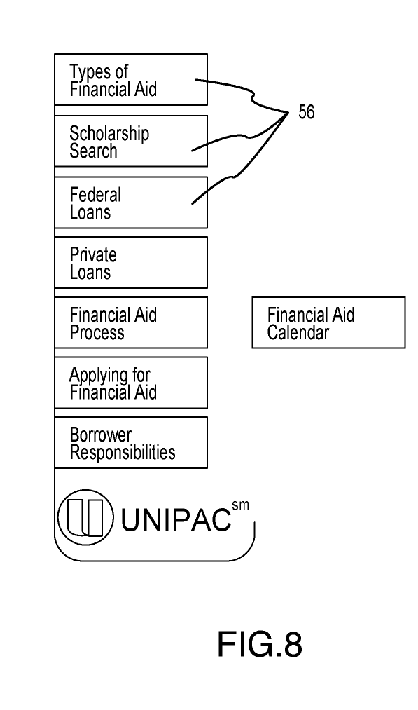

In the preferred embodiment of the present invention, the method for reducing the balance of a loan obligation using a loyalty reward program is implemented in an environment that mimics a college community, with topics primarily of interest to past, present, and future college students. Fig. 2 is a screen shot (i.e., a Web page) of the most preferred opening screen for this environment. As shown in Fig. 2, this opening screen includes a plurality of user selectable icons 28, 30, 32, 34, 36, 38, 40, 42 and corresponding hyperlinks 28', 30', 32', 34', 36', 38', 40', 42'. If a user wants to be more specifically directed to a portion of the site, sub-hyperlinks (e.g., 28'', 28''') are also available under each main hyperlink 28', 30', 32', 34', 36', 38', 40', 42'. The main hyperlinks and sub-hyperlinks together create a user-selectable outline of the Web site content. In the most preferred embodiment of the present invention, a similar user-selectable menu or outline 44 of the Web site content is provided along one edge of many of the Web site pages (see, e.g., Figs. 4 and 6). By clicking on the various topics on the user-selectable menu of options 44, a user may be quickly transported to a desired portion of the site. Figs. 7 and 8 depict optional means for navigating the site. For example, user-selectable tabs 54 (Fig. 7) may be available along an upper horizontal edge of the screen and corresponding sub-tabs 56 may be available on a vertical menu (Fig. 8). Fig. 2 also provides a button 46 to initiate new user registration, and text boxes 48, 50 that work in conjunction with button 52 to log in a previously registered user.

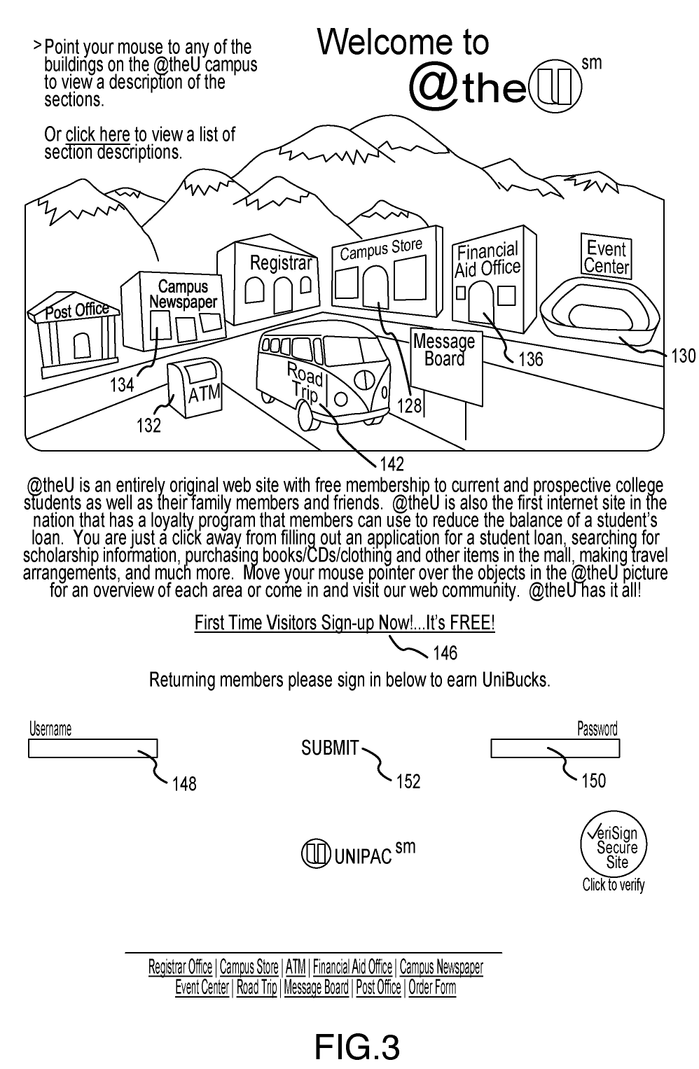

Fig. 3 is a screen shot of a possible alternative format for the opening screen. In Fig. 3, icons having functions similar to those presented in Fig. 2 are shown with a reference number being the same as those depicted in Fig. 2 but incremented by 100.

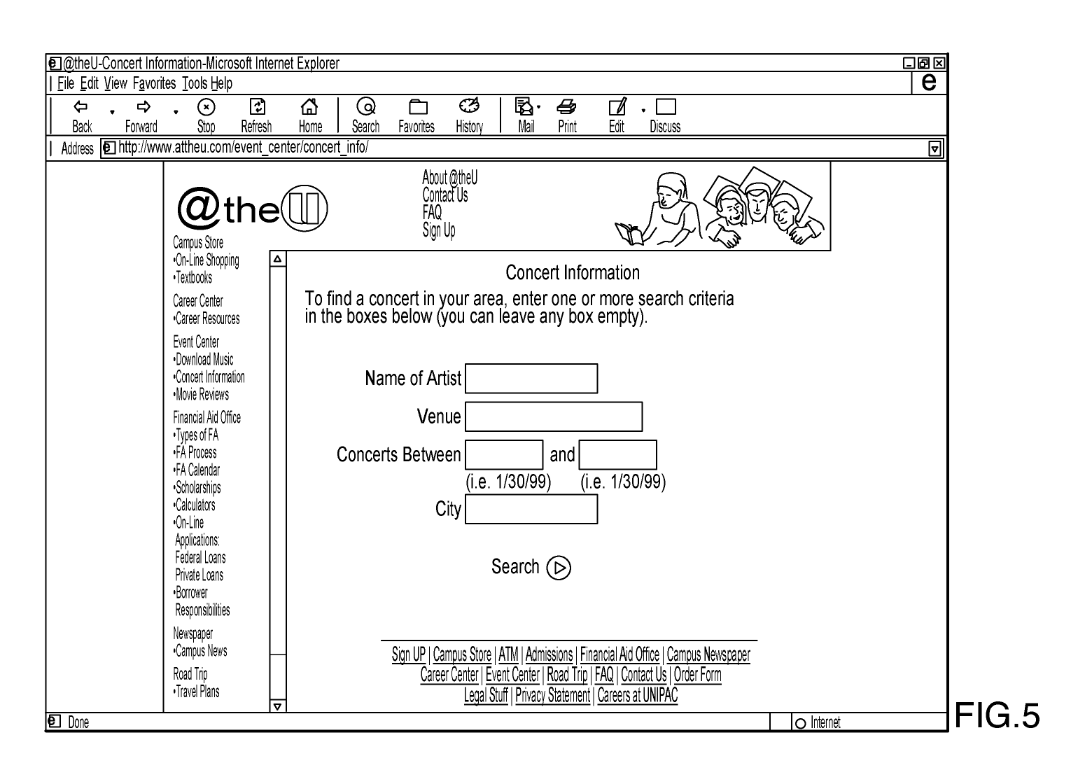

Referring next to Figs. 2 and 4-6, operation of the "Event Center" portion of the present invention is described next. If users click on the stadium icon 30 or Event Center hyperlink 30' in Fig. 2, their Web browsers are pointed to a page (see Fig. 4) where they are able to download music, obtain information about concerts (see Fig. 5), or obtain movie reviews (see Fig. 6).

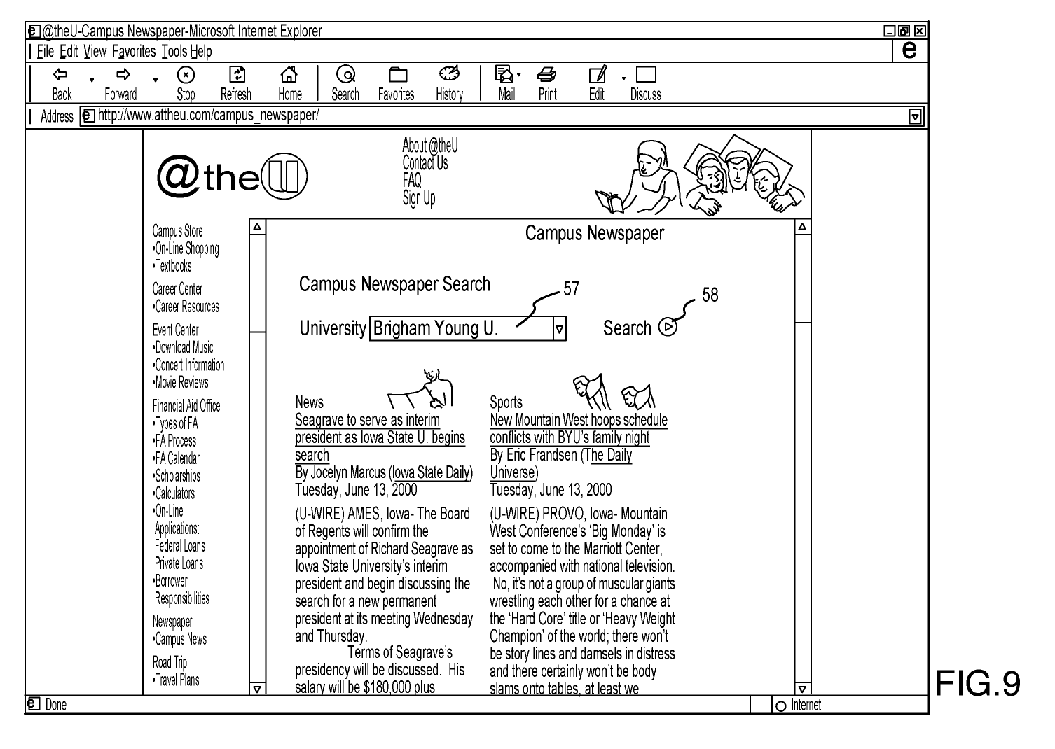

Referring next to Figs. 2 and 9, if a user selects the "Campus Newspaper" building icon 34 in Fig. 2, the user is taken to a portion of the site represented by, for example, Fig. 9. From the "Campus Newspaper" portion of the site, a user may select a desired university from a pop-up menu 57 and then search for information concerning that campus by selecting the "Search" button 58. This portion of the site provides access to current events and human interest stories from campuses around the country, and preferably includes information about the following topics: news, sports, features, entertainment, and campus life.

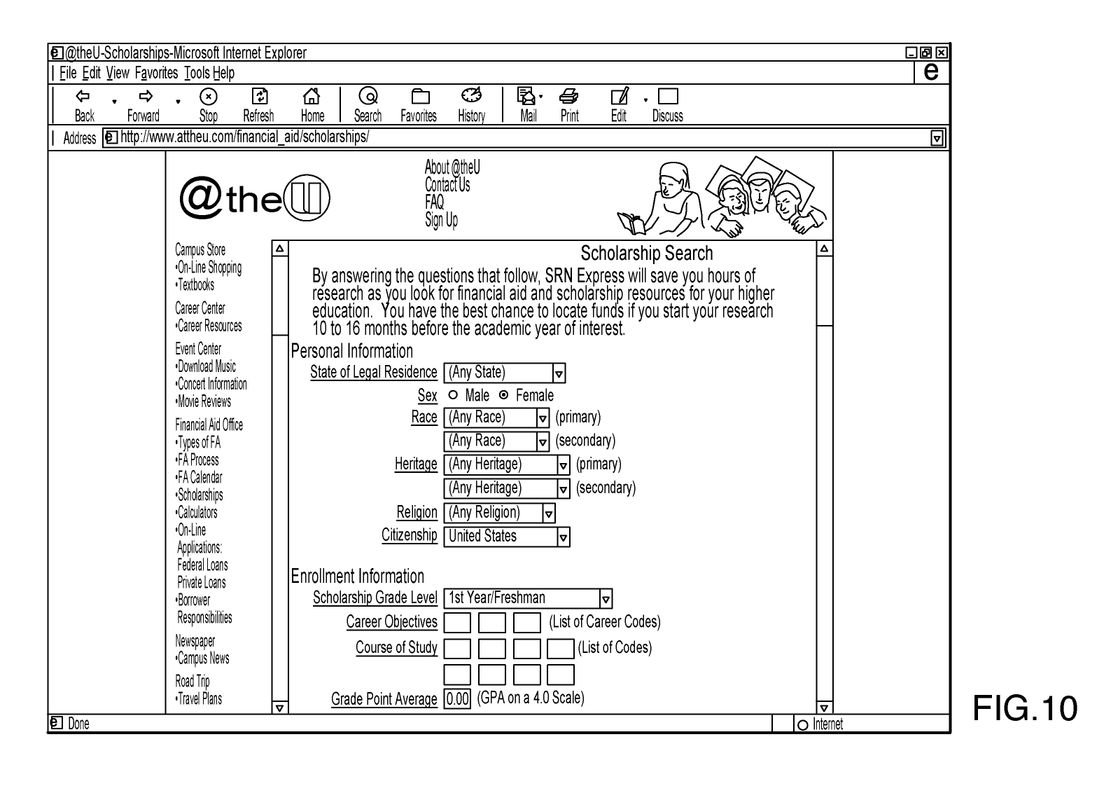

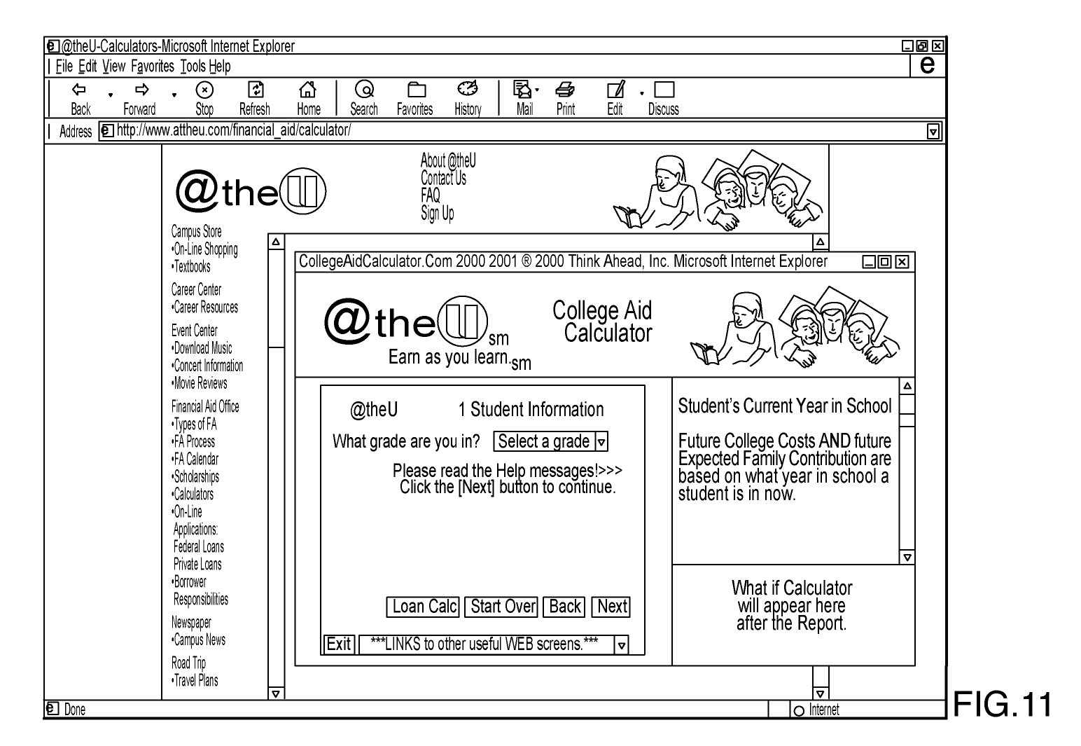

Referring to Figs. 2 and 10, the preferred embodiment of the virtual environment also permits searching for scholarships. By selecting either the "Financial Aid Office" building icon 36, the "Financial Aid Office" hyperlink 36', or the appropriate sub-hyperlink 36'' users are taken to a portion of the Web site (see, e.g., Fig. 10) where they may conduct free searches for scholarships in a national scholarships database. In the preferred embodiment, the virtual environment also provides various college aid calculators. For example, by selecting the sub-hyperlink 36''' on Fig. 2, users may be taken to a portion of the Web site represented by Fig. 11, where they can make various financial aid calculations. In the preferred embodiment, the following additional features are available from the financial aid portion of the Web site: user-friendly descriptions regarding the availability of student loans, financial aid opportunities (types of financial aid), the financial aid application process, the financial aid calendar, and borrower responsibilities. Further, in the preferred embodiment, users may apply for federal and private loans via online applications.

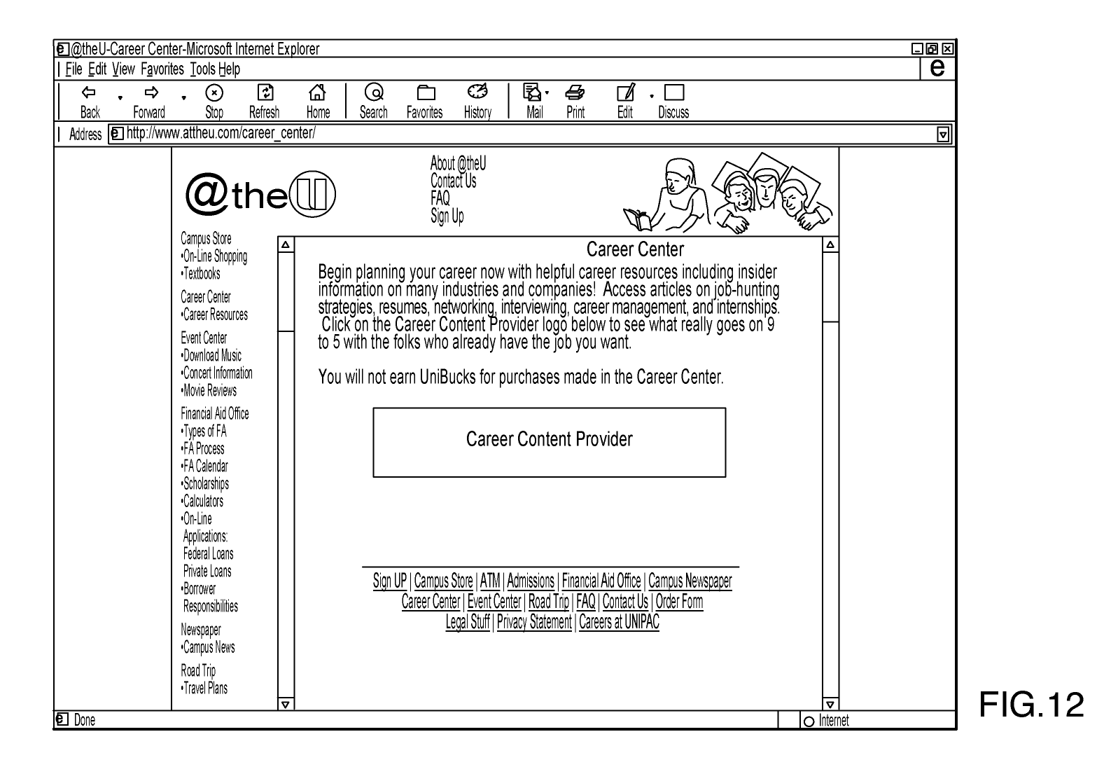

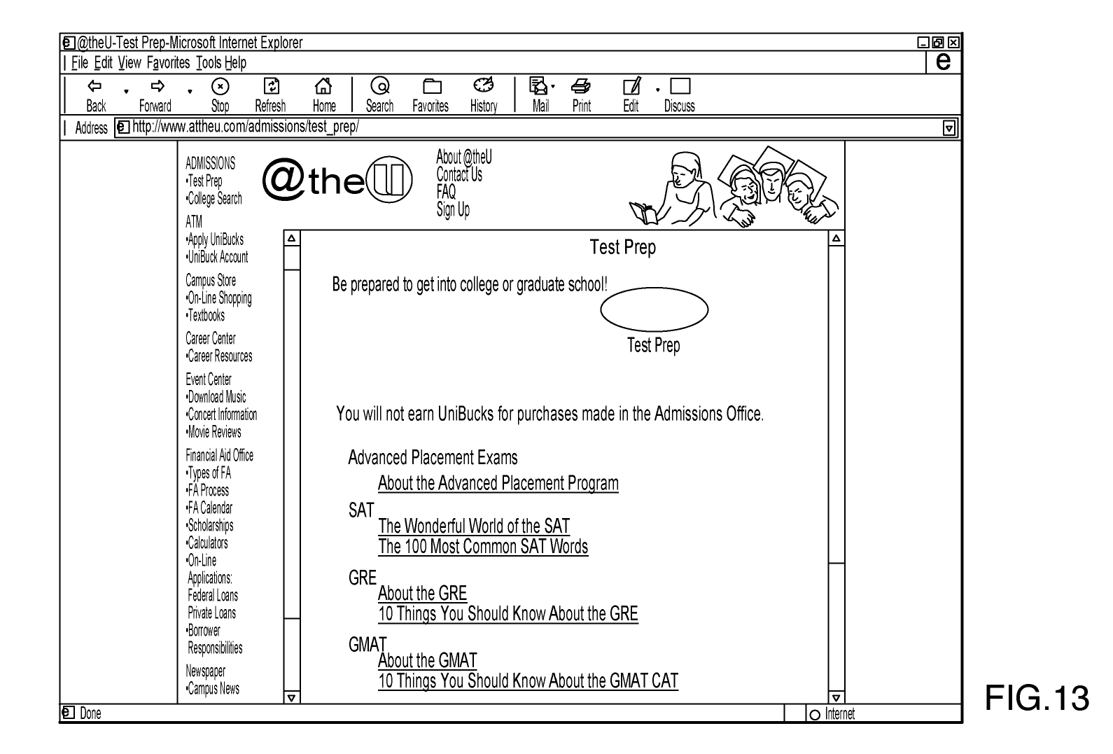

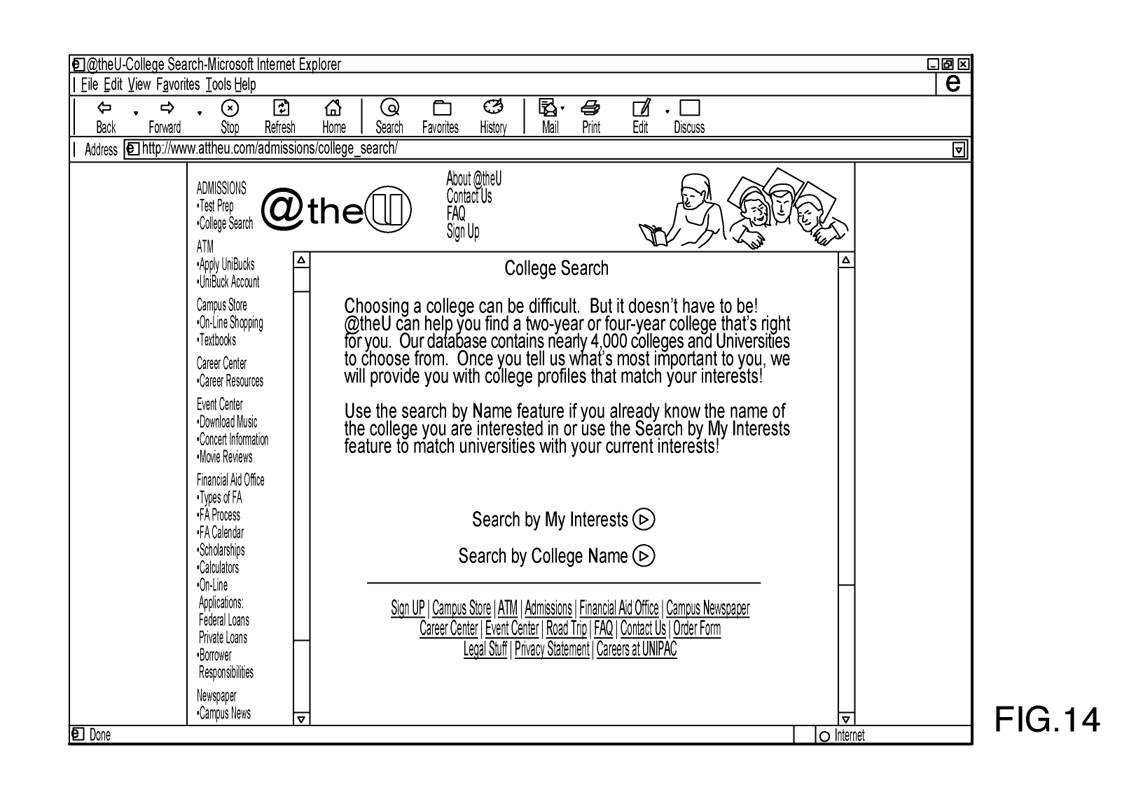

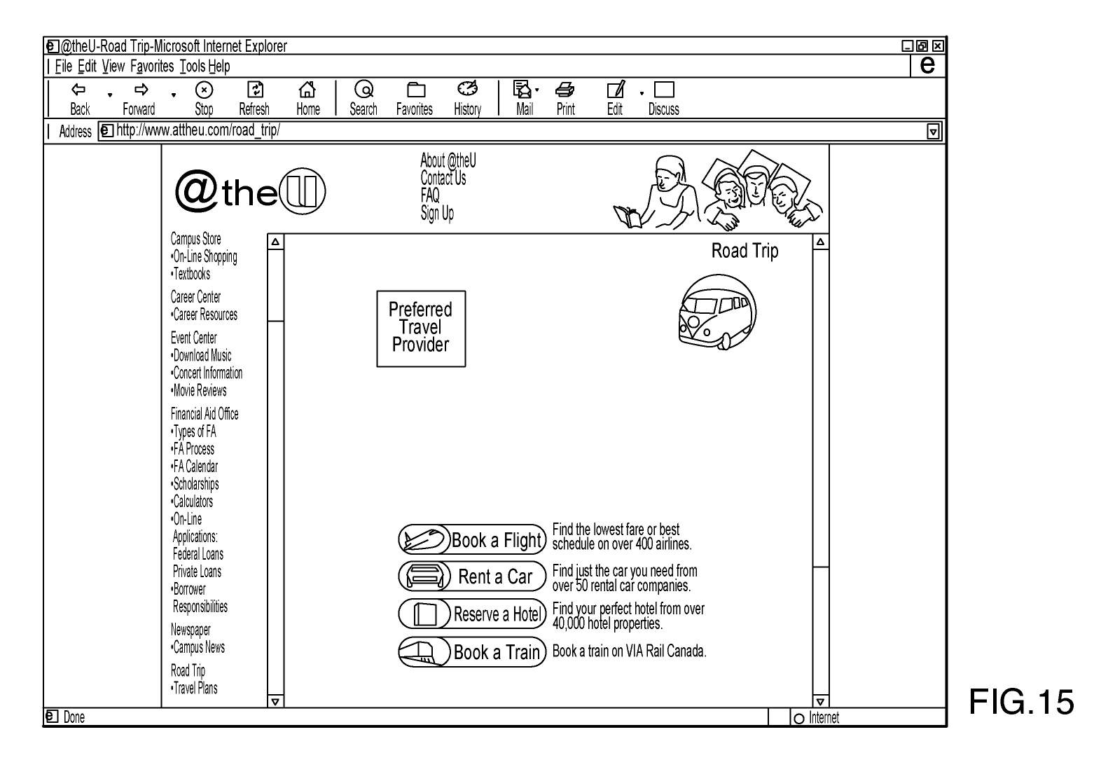

Figs. 12-15 are additional screen shots showing additional features of the site available to users through selection of appropriate icons, hyperlinks, or sub-hyperlinks from Fig. 2. For example, selection of the "Career Center" building icon 38 or hyperlink 38' may result in a screen similar to Fig. 12 being presented to the user. Similarly, selection of the "Test Prep" sub-hyperlink 40'' in Fig. 2 would take the user to a portion of the Web site represented by, for example, Fig. 13, relating to test preparation. If a user were to select the "College Search" sub-hyperlink 40''' in Fig. 2, they are taken to a portion of the Web site represented by the sample screen shot of Fig. 14. From the screen depicted in Fig. 14, the user could search for a college of interest. Fig. 15 is a sample screen shot depicting what a user might see after selecting the "Road Trip" vehicle icon 42 or hyperlink 42' of Fig. 2. At this portion of the Web site, an online travel service provides the ability to browse airline and hotel information and book preferred accommodations. For example, users may book a flight, book a train ride, rent a car, or reserve a hotel room. The remaining two icons on Fig. 2, namely the "Campus Store" building icon 28 and the "ATM" icon 32, relate most specifically to the invention of the present application and are discussed further below.

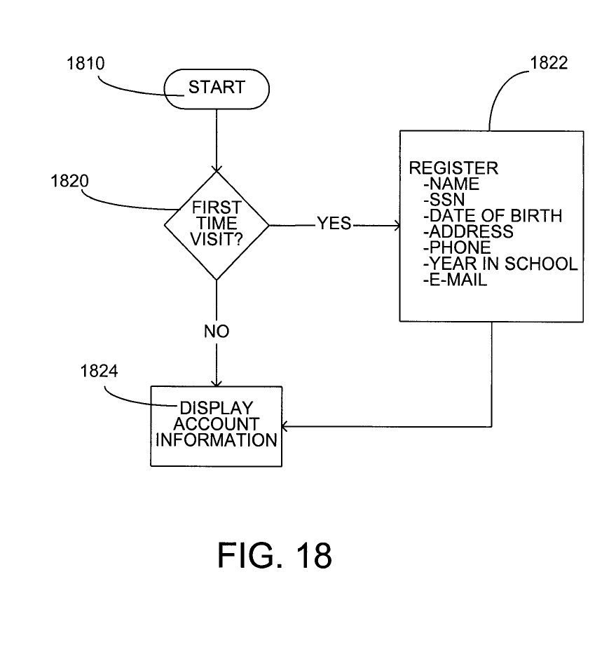

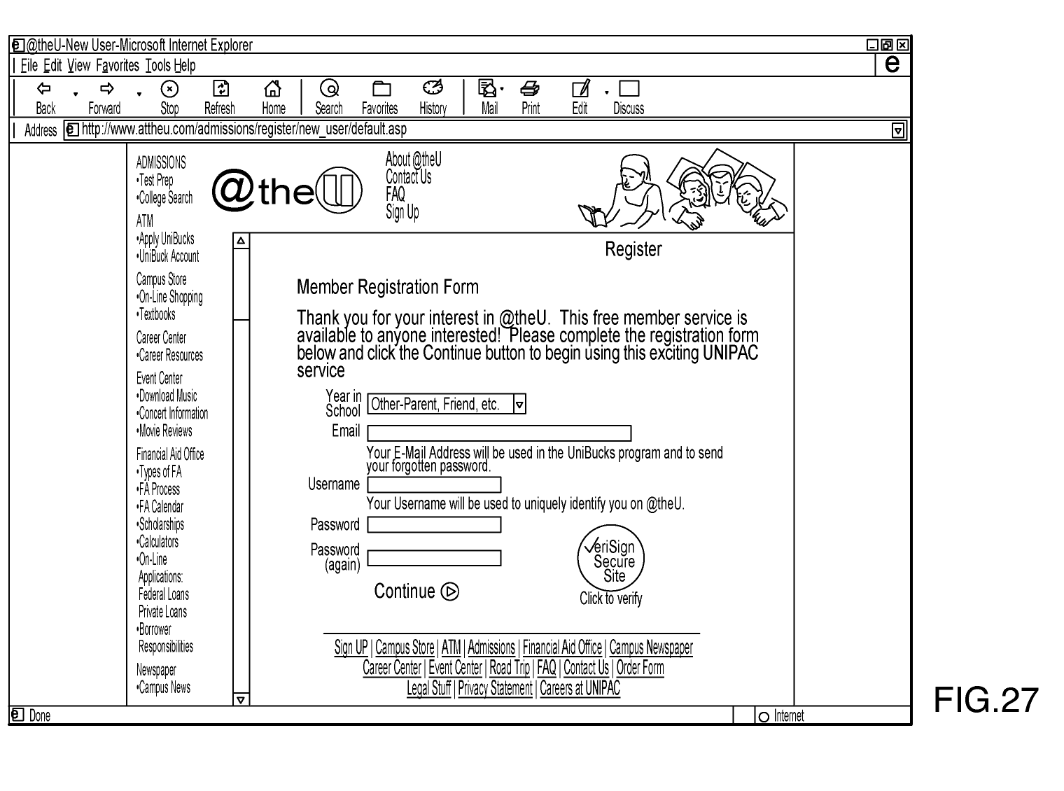

Fig. 16 is a flowchart of the overall method according to the present invention. From initial block 1610, the process first checks at block 1612 to see whether the user is a new user. In order for users to make purchases and to accumulate, view, and redeem "loyalty points" (known as "UniBucks" in the preferred embodiment), they must be registered. Nonregistered users may, however, use other features of the site. As discussed further below in connection with Fig. 18, it is also necessary to be registered to view loan information. "Loyalty points" are awarded to members of the site to reward and encourage the members' continued allegiance to the site. Loyalty points may be applied to reduce the balance of a present loan obligation, or they may be saved and later applied to future loan obligations. If at block 1612 the system determines that the user is a new user, the system requires the user to register at block 1614. Users are registered by requiring them to complete a member registration form like the one shown in, for example, Fig. 27. As part of the registration process, information concerning the user is stored in a participant table 1616. At this point, the user is now a registered user or member, and control transfers to block 1618. In the preferred embodiment, the system sends a confirmatory email to newly-registered users. If the now-registered user later returns, at block 1612 program flow will immediately transfer to user sign-in at block 1618. After a user signs in, that user may either accumulate loyalty points (block 1620), or view and redeem previously accumulated loyalty points (block 1624).

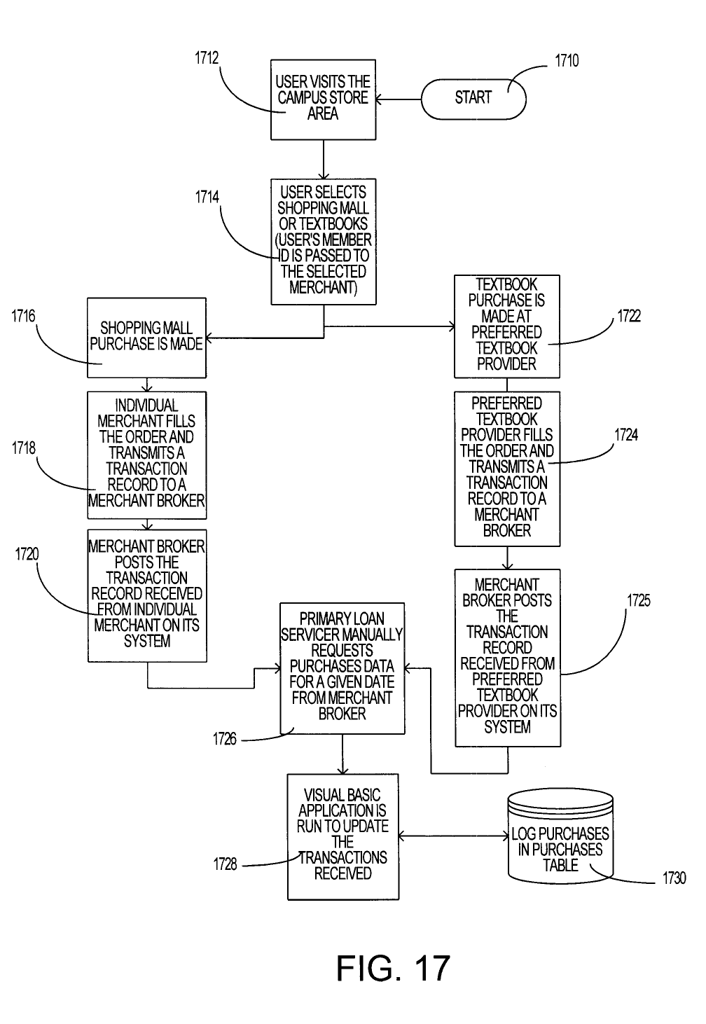

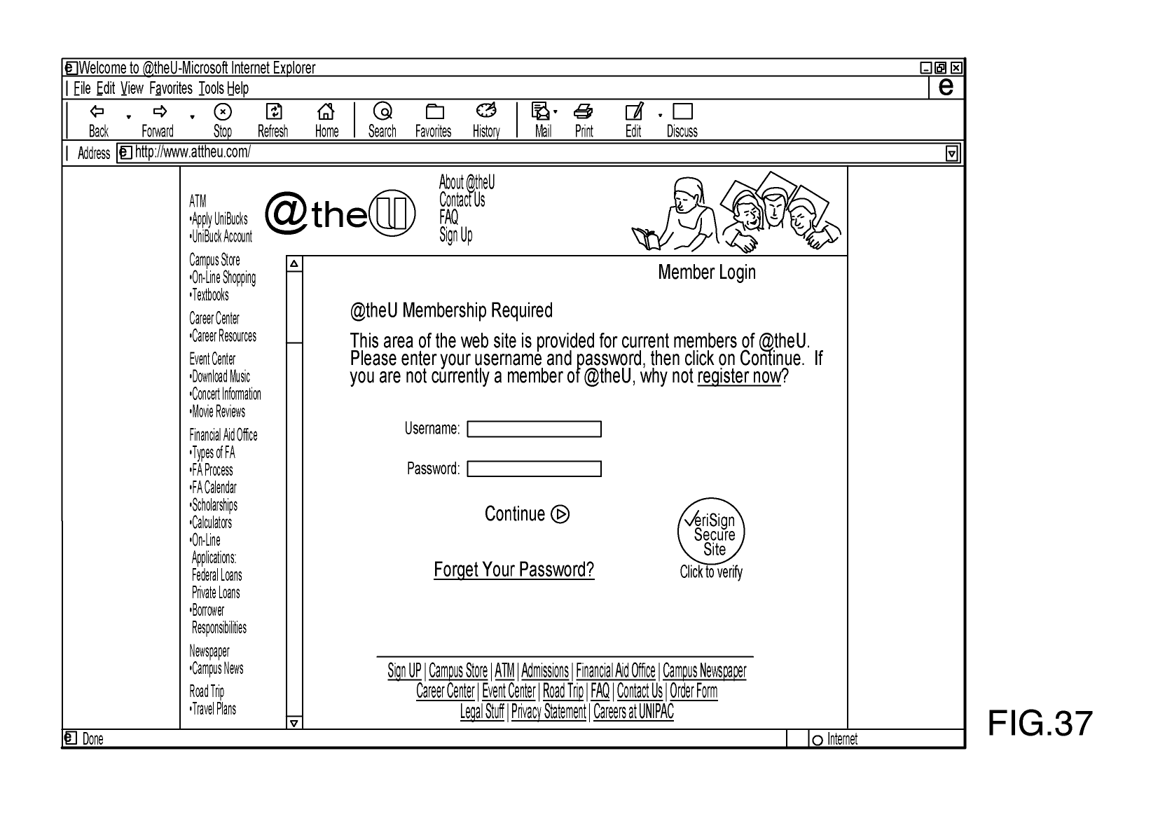

Considering accumulation of loyalty points first, at block 1622 of Fig. 16, control transfers to block 1710 of Fig. 17. Fig. 17 is a flowchart of the process by which loyalty points are accumulated and tracked in the present invention. One way that a user may accumulate loyalty points is to visit the "Campus Store" portion of the Web site, which is represented by block 1712. The "Campus Store" is the e-commerce component of the site where a user may purchase merchandise via online shopping. A user of the site may visit the Campus Store by clicking on the building icon 28 or Campus Store hyperlink 28' (Fig. 2). If users attempt to make purchases at the Campus Store before they are logged in, they are presented with a log-in screen like that shown in Fig. 37

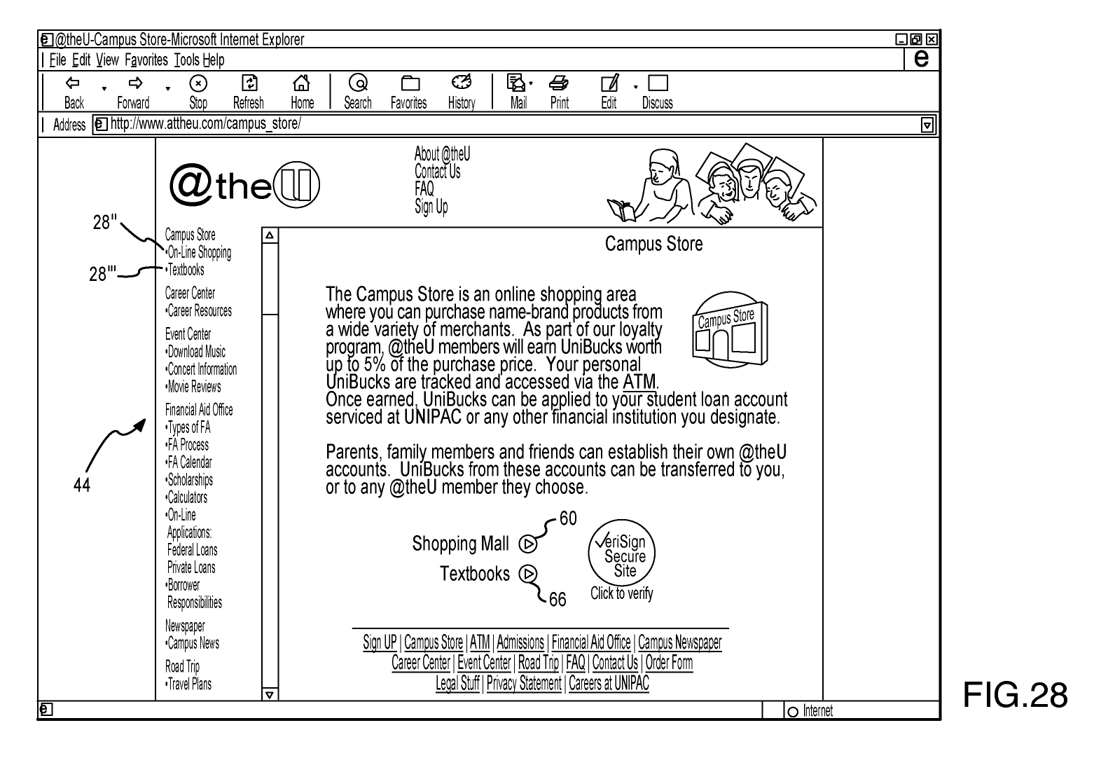

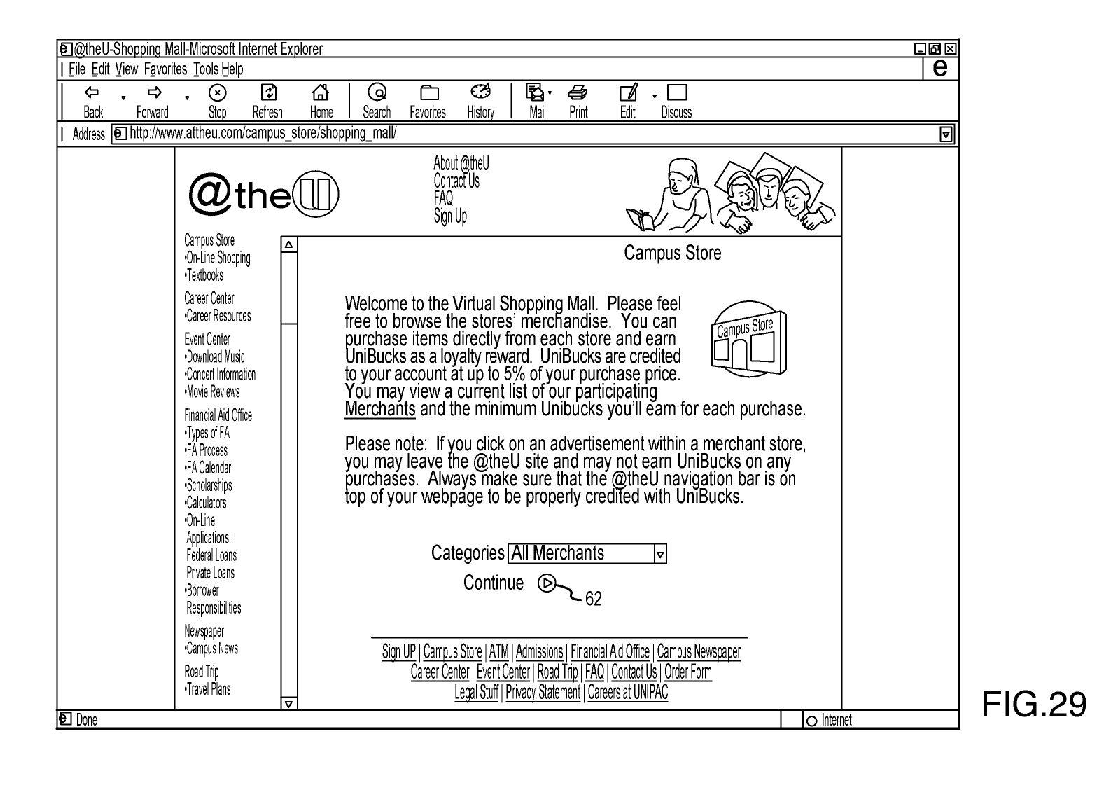

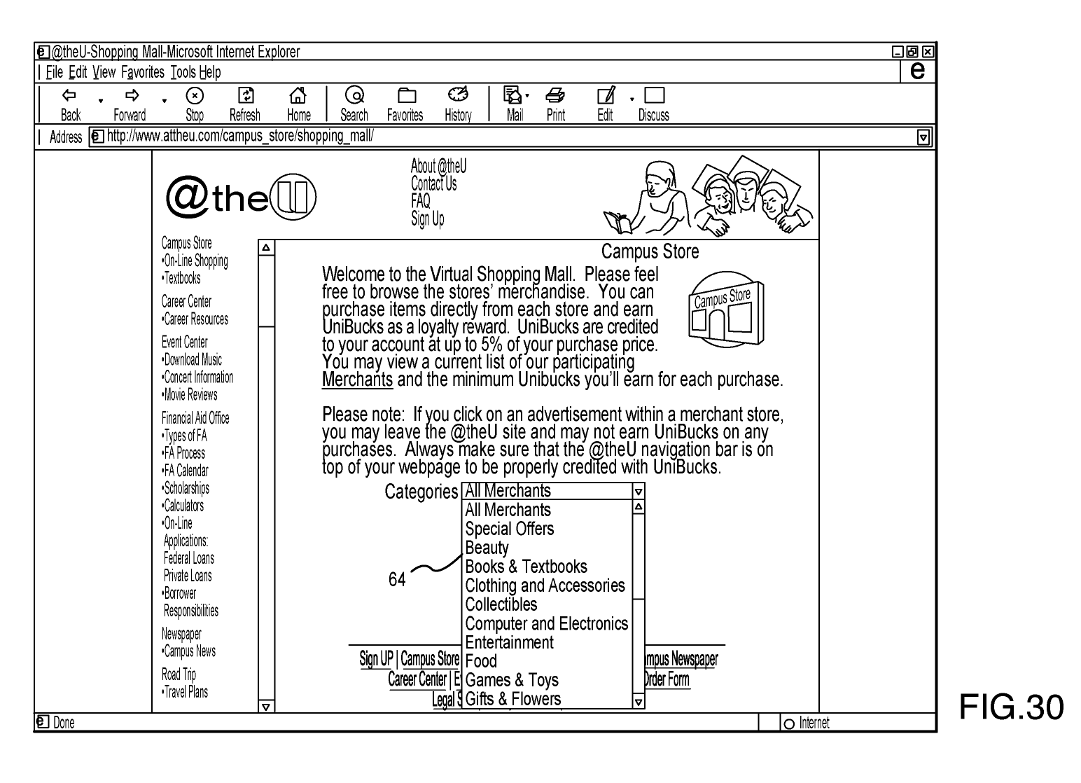

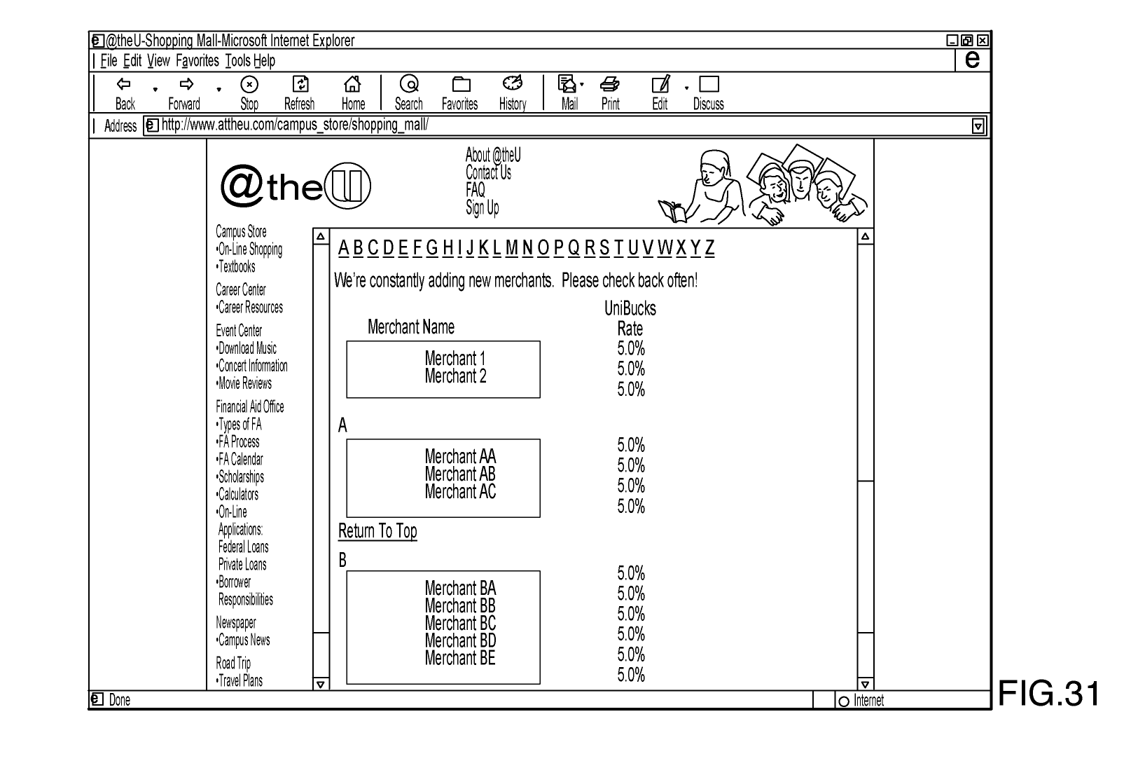

After clicking on the "Campus Store" icon 28 or hyperlink 28', the user is taken to a screen like that shown in Fig. 28. At this point, the user may purchase name-brand products (for example, clothing, computer hardware and software, and electronics) by selecting either the "Shopping Mall" button 60 or the "Textbooks" button 66 (Fig. 28). This selection is represented by block 1714 of Fig. 17. Alternatively, the user could visit the Shopping Mall portion of the site by clicking on the "On-Line Shopping" hyperlink 28'' (Fig. 28) of the user-selectable menu 44 at the left-hand side of most screens, or the user could visit the Textbooks portion of the site by clicking on the "Textbooks" hyperlink 28''' from the user-selectable menu 44. If the user elects to visit the Shopping Mall portion of this site, this will take the registered user to a screen similar to Fig. 29. At the Fig. 29 screen, the user may select a "Continue" button 62 to view a list of all available merchants, a sample portion of which is shown in Fig. 31, or the registered member may select from a pop-up list of merchant categories 64 as shown in, for example, Fig. 30.

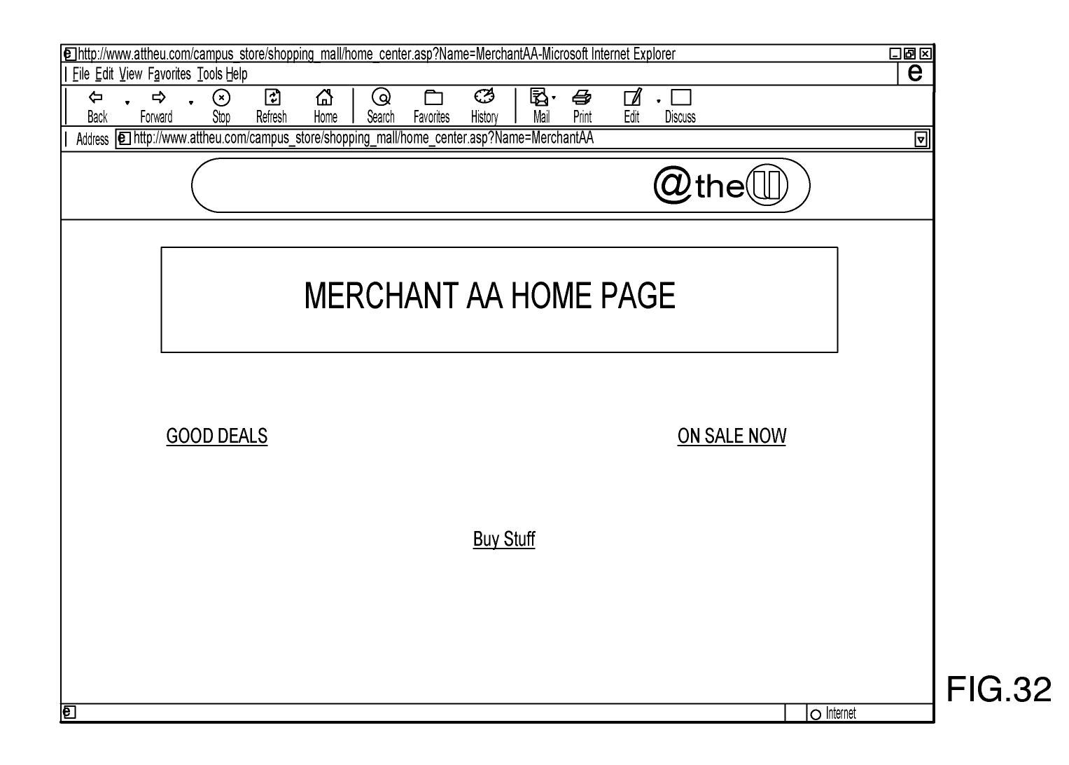

If the registered member decides to select a merchant from the list of all available merchants (e.g., Fig. 31), the user points their browser at a particular selected merchant's Web site by clicking on that merchant's name in the list of available merchants (Fig. 31). For example, if the user selected "Merchant AA" in Fig. 31, the user is directed to Merchant AA's site on the global computer network as shown in Fig. 32. In Fig. 32, Merchant AA's site is framed by a border identifying the site established by the primary loan servicer.

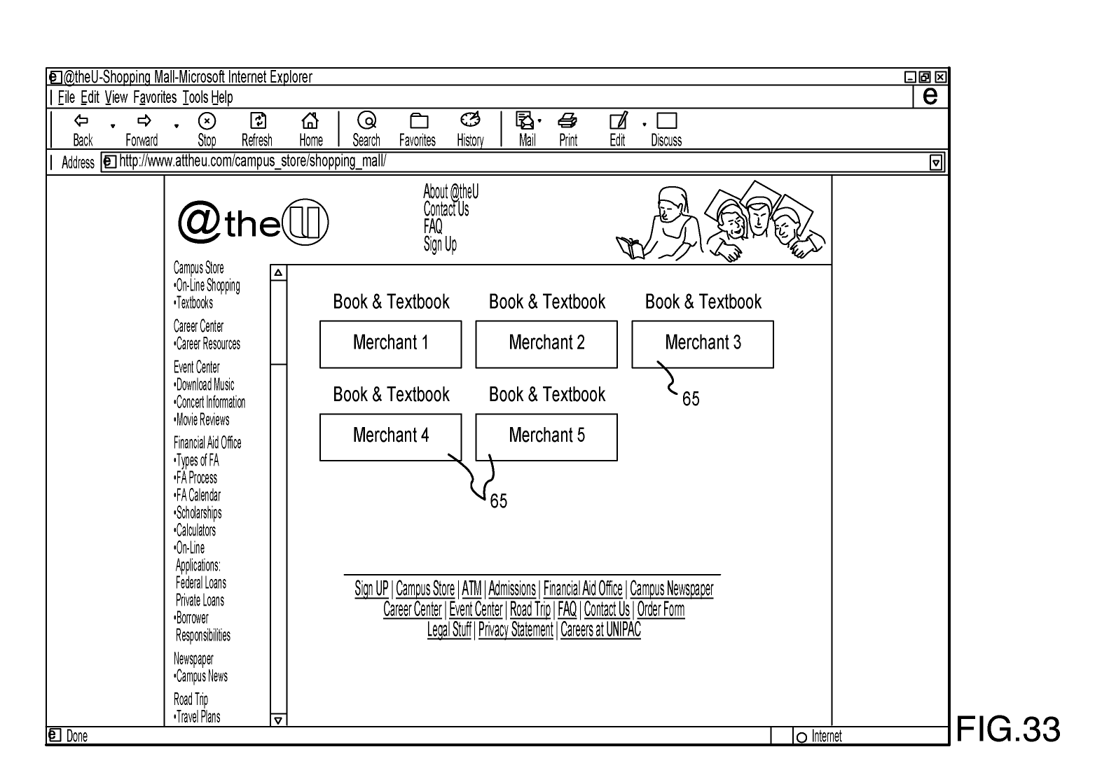

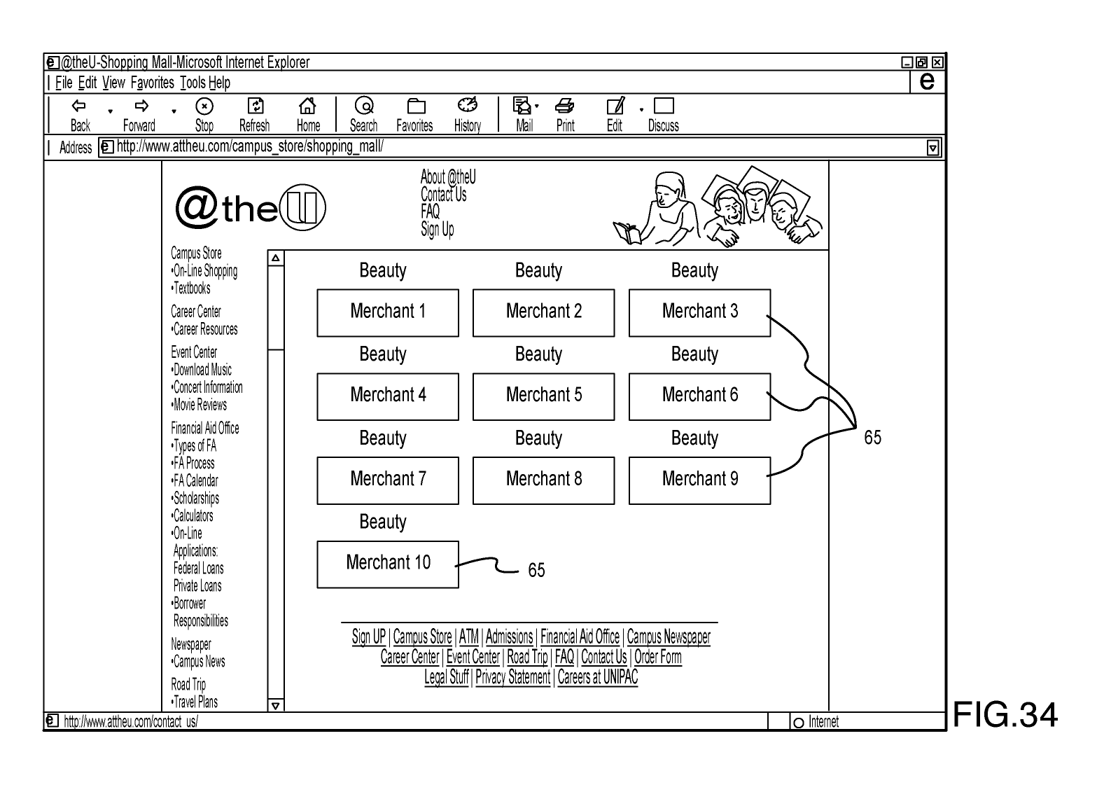

If, on the other hand, the registered user selected a particular category from the pop-up list 64 of available categories (Fig. 30), a list of merchants who sell goods in the selected category is displayed. For example, Fig. 33 displays a list of merchants falling under the "Books and Textbooks" category in the pop-up menu 64 displayed in Fig. 30. Similarly, Fig. 34 displays the available merchants who sell products that fall in the "Beauty" category from the pop-up menu 64 displayed in Fig. 30. From a category specific list of merchants like those shown in Figs. 33 and 34, registered users click on the selected merchant's icon 65 to point their browsers at that particular merchant's Web site. In the most preferred embodiment, the pop-up menu 64 includes the following categories: All Merchants, Special Offers, Beauty, Books and Textbooks, Clothing and Accessories, Collectibles, Computer and Electronics, Entertainment, Food, Games and Toys, Gifts and Flowers, Health, Home and Garden, Online Education, Optical, Pets, School and Office Supplies, and Sports and Fitness.

Once at the selected merchant's Web site, either by selecting the merchant from the full list of merchants (see Figs. 31 and 32) or by selecting the merchant from a category-limited list of merchants (see Figs. 30, 33, and 34), the registered user follows the particular merchant's process for purchasing goods. Loyalty points are accumulated as a percent of the purchase price. The particular percentage varies by vendor based upon pre-arranged merchant agreements. In the preferred embodiment, users can accumulate loyalty points at up to 5percent of the purchase price. The number of loyalty points earned by making a particular purchase at a merchant's Web site is automatically tracked by the system as explained further below.

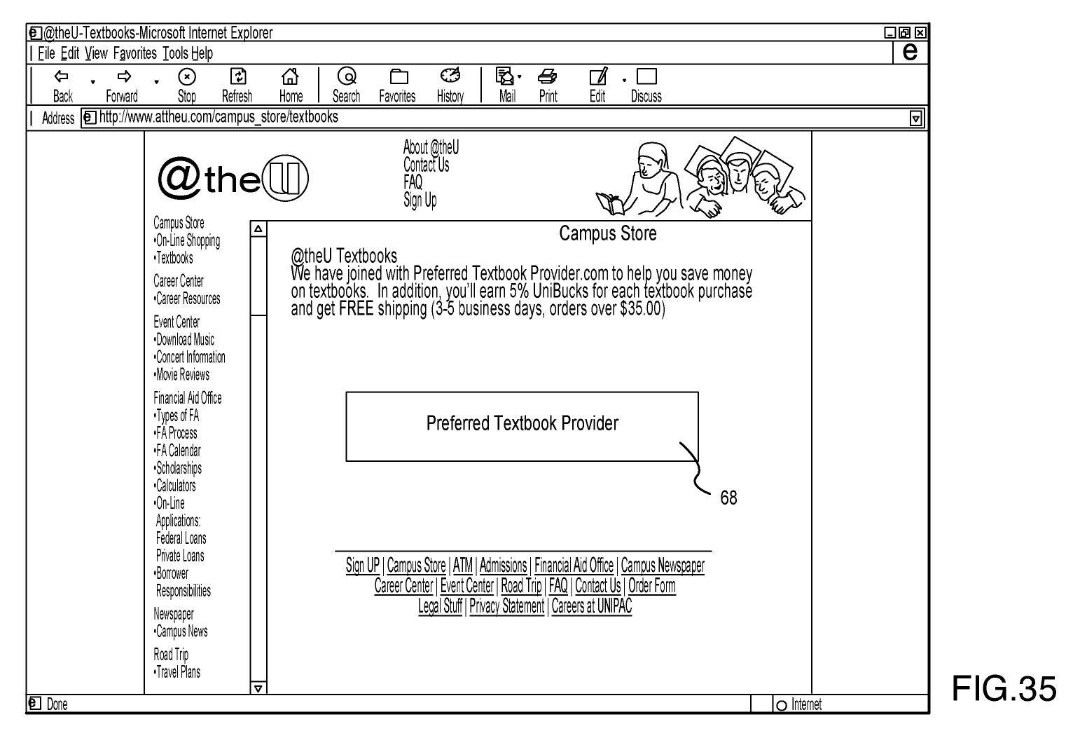

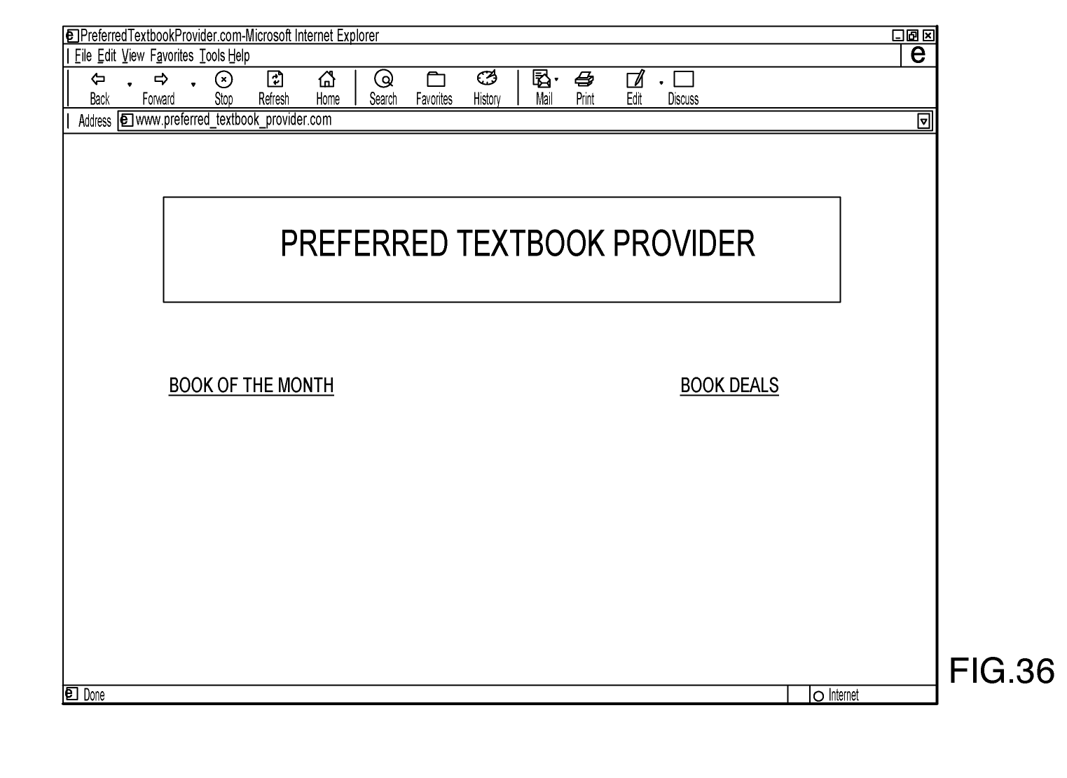

If, at Fig. 28, the registered member wants to purchase textbooks only and thus elects to visit the "Textbooks" portion of the site, they could select the "Textbooks" button 66 on the screen depicted in Fig. 28. That selection would take the user to a portion of the Web site represented by, for example, Fig. 35. Clicking on the icon 68 displayed in Fig. 35 points the user's browser to the Web site of the preferred textbook merchant (see, e.g., Fig. 36). Purchases made at the preferred textbook merchant's Web site accumulate loyalty points that again are automatically tracked by the system as discussed further below. In Fig. 36, the user has been hyperlinked to the preferred textbook provider's site on the global computer network.

Returning to Fig. 17, as noted in block 1714, when a user selects the "Shopping Mall" button 60 or the "Textbooks" button 66 (Fig. 28) from the Campus Store, the user's member ID, which was assigned to the user upon registration, is passed to the ultimately-selected merchant. This information about the user's member ID is used to track that member's accumulated loyalty points. If a registered user makes a purchase at the online Shopping Mall (block 1716), the selected individual merchant fills the order, and, in the preferred embodiment, transmits information about the transaction to a "merchant broker" (block 1718). It is common practice for online companies to use the services of "merchant brokers." As used herein, a "merchant broker" is an entity having established business relationships with a plurality of individual merchants whose products an online company wants to offer to its registered users. As part of those relationships, the merchant broker typically has commission structures prearranged with the individual merchants. For example, Company X may enter into an agreement with the merchant broker to pay the broker, as a commission, Y percent of sales brought to Company X by the merchant broker. The merchant broker then brings business to Company X by establishing additional relationships with other companies. For example, the merchant broker may work out a deal with Company Z whereby the merchant broker offers to share with Company Z part of the commission the merchant broker receives from Company X for sales brought to Company X by Company Z via the merchant broker. The merchant broker thus motivates Company Z to direct its customers to Company X by offering to pay Company Z a commission based upon the sales of Company X's products to Company Z's registered users.

In the preferred embodiment of the present invention, the primary loan servicer uses LinkShare, Inc. of New York, New York, as its merchant broker. When the primary loan servicer learns of a LinkShare merchant whose products the primary loan servicer wants to offer to its registered users, the primary loan servicer makes the necessary arrangements with LinkShare. In the preferred embodiment, the merchant broker, among other things, assigns merchant identification numbers, provides marketing resources and data, and collects raw sales and commission data, which it electronically reports to the primary loan servicer as discussed further below. The primary loan servicer incorporates the marketing and resource data into its site for presentation to its registered users. As discussed further below, the primary loan servicer further processes the raw sales and commission data received from the merchant broker. As part of that further processing, the primary loan servicer determines the number of loyalty points to give its registered members based upon where (i.e., which merchant) and what (i.e., which product) they purchase through the primary loan servicer's site. In the preferred embodiment, the loyalty points equal part of or all of the commission share offered by the merchant broker to the primary loan servicer. Before buying Company X's product, the registered members of the primary loan servicer's site can look up what percentage of the purchase price they will accumulate in loyalty points by making their purchases through the primary loan servicer's site. Thus, the registered members are motivated to buy Company X's products or services through the primary loan servicer's site because the members know they will accumulate loyalty points from the primary loan servicer based upon those purchases. As discussed further below, the registered members may apply their accumulated loyalty points to reduce a loan obligation, or they may transfer their accumulated loyalty points to other registered members. Referring to Fig. 17, in the preferred embodiment, the merchant broker eventually posts the transaction record received from individual merchants on the merchant broker's system (block 1720).

If a registered user selected the "Textbooks" button 66 (Fig. 28), the purchase is made at a preferred textbook merchant's site (block 1722), but the process is otherwise the same as it is for "Shopping Mall" purchases. The primary loan servicer may have made special arrangements with the preferred textbook provider. At block 1724, the preferred textbook provider fills the order and creates a transaction record, which it transmits to the same or a different merchant broker. In the preferred embodiment, the merchant broker again eventually posts the transaction record received from the preferred textbook provider on the merchant broker's system (block 1725).

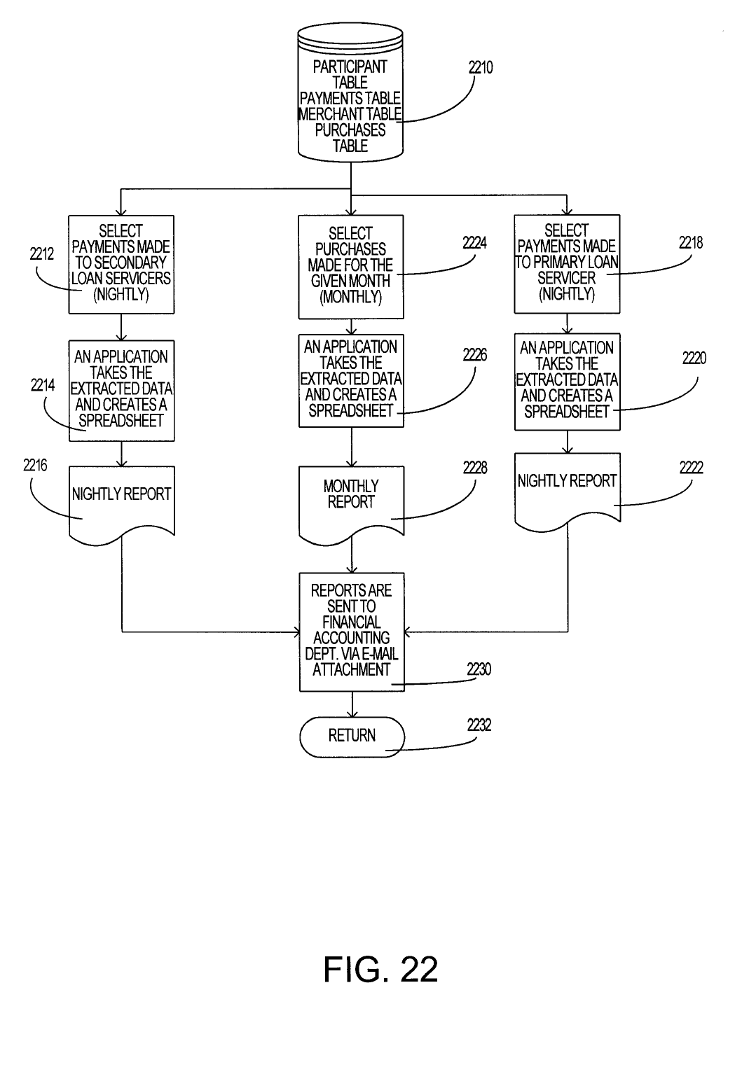

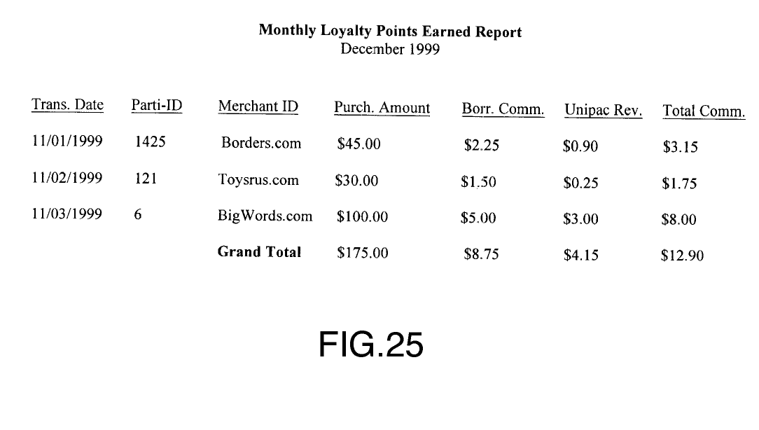

Transaction records, whether posted by a merchant broker (blocks 1720 and 1725) or made available directly from a particular merchant (not shown), are manually requested by the primary loan servicer from the merchant broker(s) or from one or more individual merchants (block 1726). In the preferred embodiment, these transaction records are received electronically on a daily basis. At block 1728, the primary loan servicer then runs an application to update its transaction records and to log the transactions in a purchase table 1730. The process for tracking accumulated loyalty points is further discussed below in connection with Figs. 22 and 25.

Returning to Fig. 16, if after signing in at block 1618, a user elects to view accumulated loyalty points ("pending" or "earned") or redeem ("apply" or "transfer") earned loyalty points, the process continues from block 1618 to block 1624. In the preferred embodiment, loyalty points are posted in an initial status of "pending" (accumulated and pending) for a predetermined "waiting period" (e.g., 30 days). This waiting period allows for, among other things, product returns, refunds, and credits; and it reduces the chance of fraud. After the predetermined waiting period passes, the loyalty points become "earned" (accumulated and earned), at which time they are fully available to "redeem" (i.e., apply to a present loan obligation or transfer to another registered user). A registered member displays loyalty point information using a loyalty points manager (block 1626).

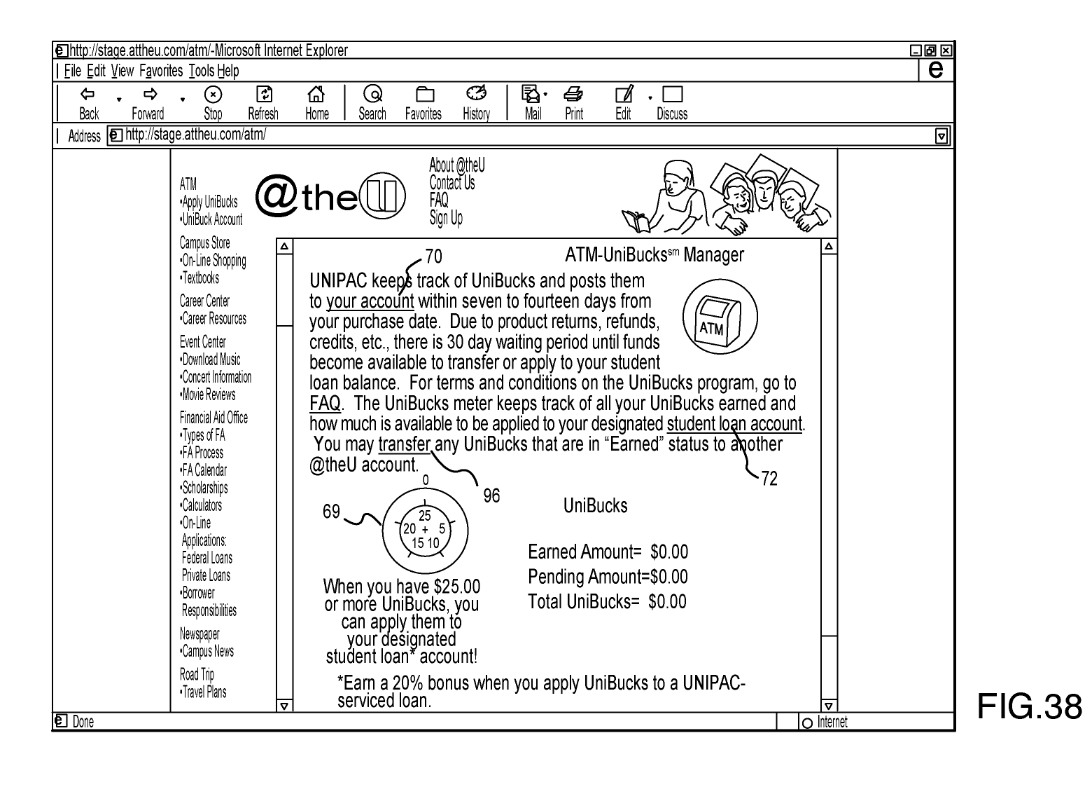

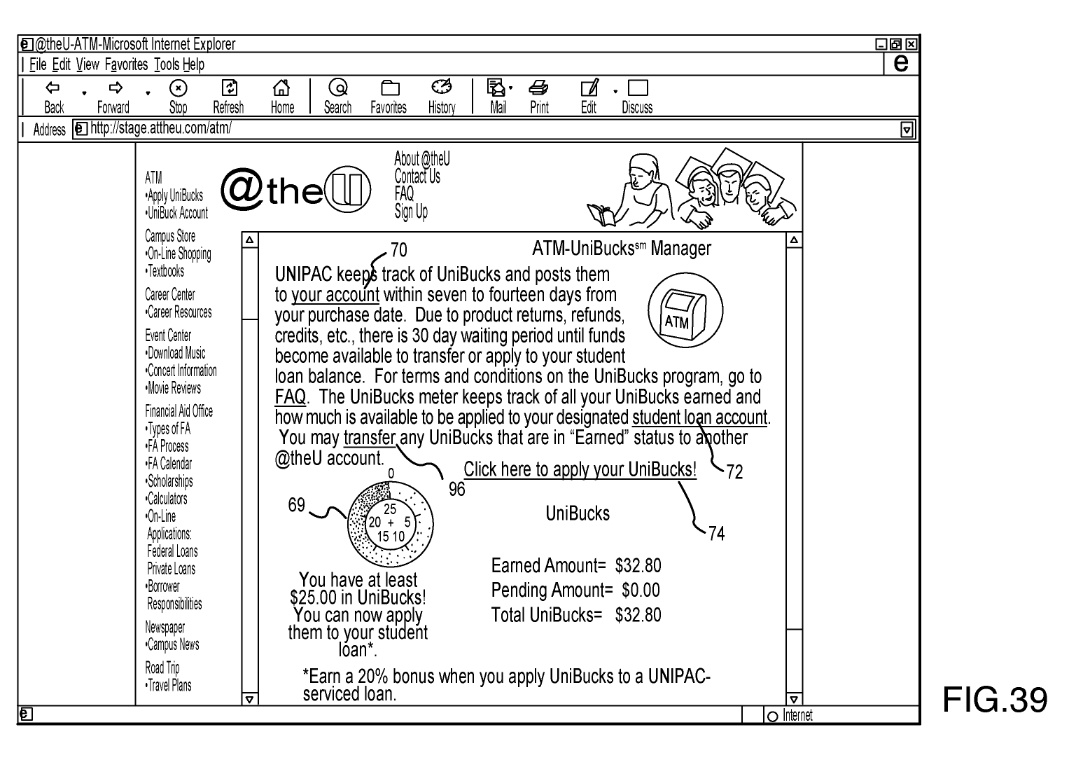

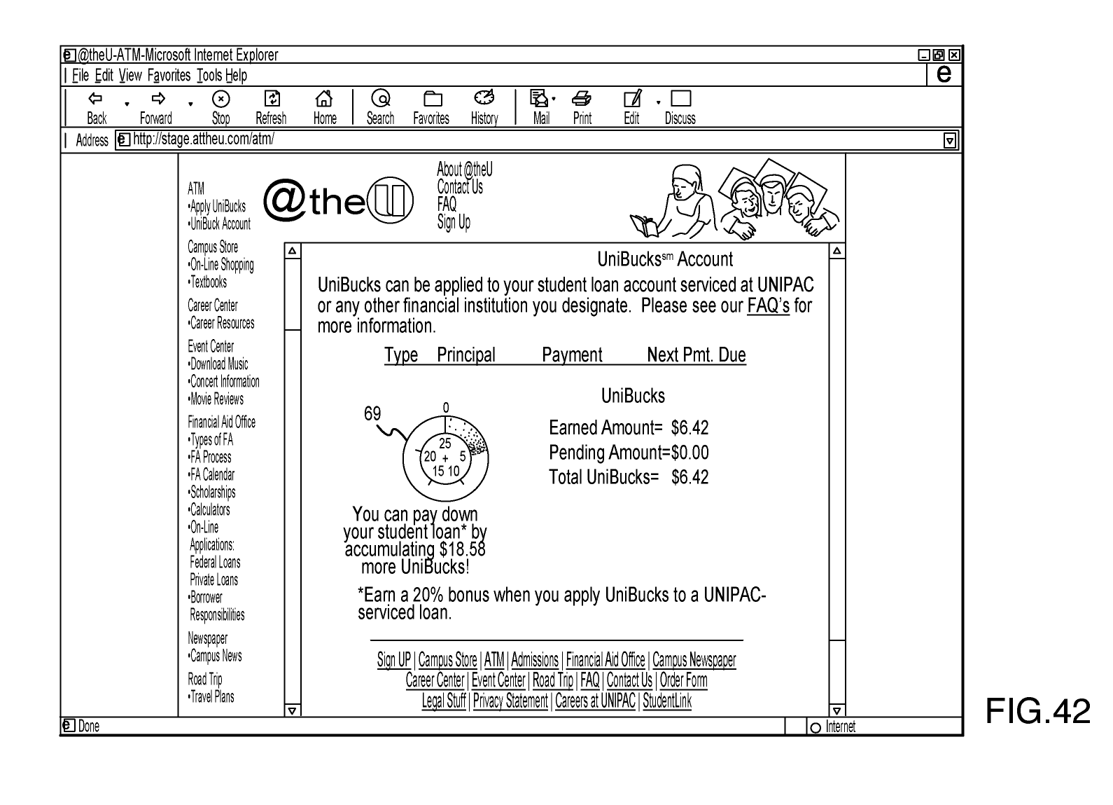

In the most preferred embodiment, where the loyalty points are known as UniBucks, the loyalty points manager is a "UniBucks Manager" accessed by clicking on a simulated automatic teller machine (ATM) icon 32 (Fig. 2). Clicking on the "ATM" icon 32 takes the user to a screen like that depicted in Fig. 37 if the user is not logged in, or to a screen like those depicted in Figs. 38 and 39 if the user is currently logged in. As depicted in Figs. 38 and 39, from the UniBucks Manager screen users receive summary information about their UniBucks accounts, including a meter graphic 69, which graphically indicates the user's progress toward earning the minimum number of loyalty points that may be "applied." In the preferred embodiment, the minimum number of loyalty points that may be "applied" is twenty-five. Thus, the meter graphic 69 indicates a registered member's progress toward accumulating twenty-five earned UniBucks. In Fig. 38, the user has no earned loyalty points. Thus, the meter graphic 69 shows no earned UniBucks. In contrast, in Fig. 39, for example, the meter graphic 69 shows that the registered member has earned at least twenty-five loyalty points (i.e., UniBucks). Fig. 42 shows a meter graphic 69 where the user has accumulated some loyalty points, but not twenty-five. At block 1628 (Fig. 16), a user thus may visually verify if sufficient loyalty points have been earned. In the preferred embodiment, that involves reviewing the summary information about the number of earned UniBucks displayed on a screen like those shown in Figs. 38 and 39.

From block 1628 of Fig. 16, a user may view loyalty point account details (block 1630), view loan information for loans serviced by the primary loan servicer (block 1632), apply earned loyalty points to reduce the balance of a present loan obligation (block 1634), or transfer earned loyalty points to another registered member (block 1636). Each of these options is described below.

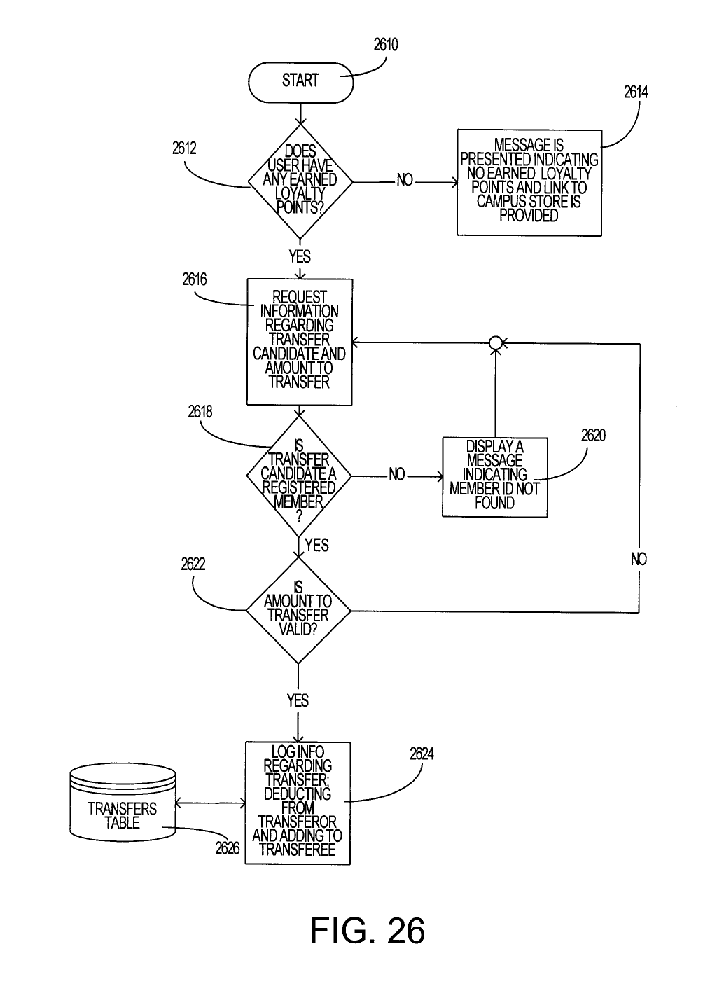

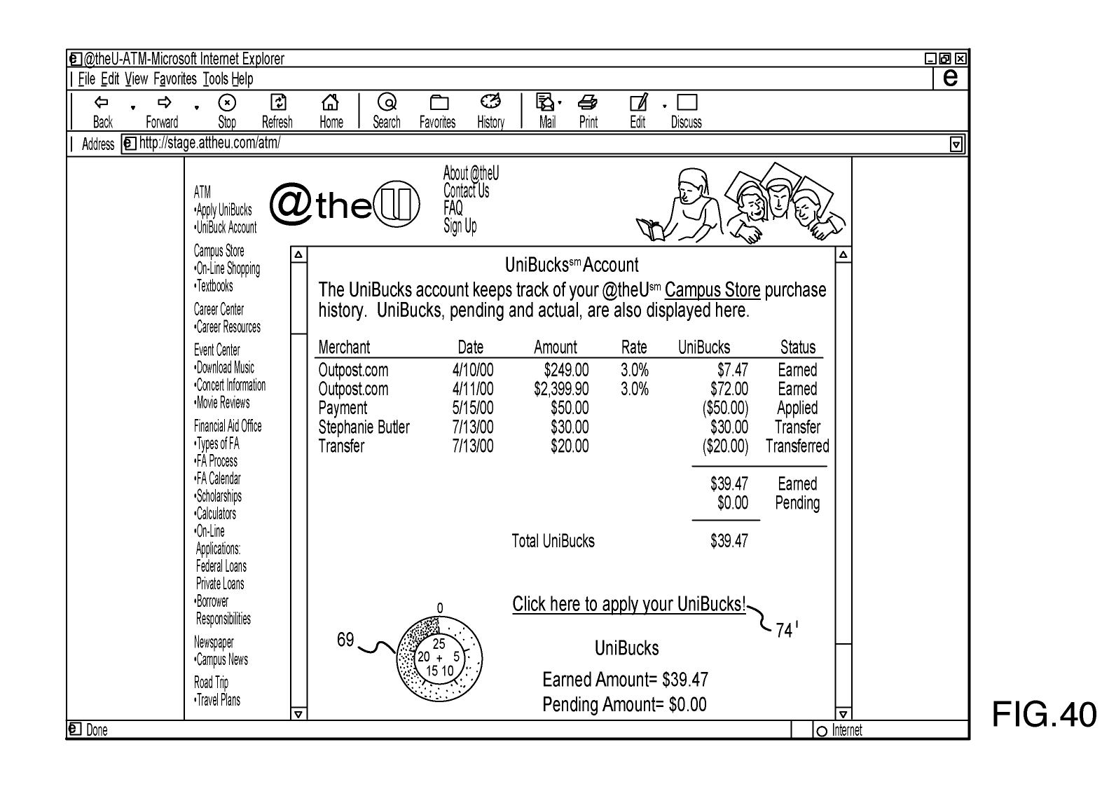

If a user elects to view loyalty point account details (block 1630 of Fig. 16), the user may, for example, click on the "your account" hyperlink 70 shown in Figs. 38 and 39. A registered member who clicks on the "your account" hyperlink 70 is taken to a screen providing more detailed information about the user's loyalty points account (see e.g., Fig. 40). Fig. 40 displays detailed account information related to the user account for which summary information is presented in Fig. 39. Fig. 39 only provides information about earned loyalty points, pending loyalty points, and total loyalty points. Fig. 40 provides a more detailed breakdown of the earned and pending loyalty points. For example, as shown in Fig. 40, the member received two hundred loyalty points from a purchase, transferred a total of thirty-nine loyalty points to other registered members in two transfers, and received fifty loyalty points transferred to the user from another registered member. As shown in Fig. 40, loyalty points involved in a transfer between registered users, have a "status" of either "transfer" and "transferred." "Transferred" status indicates loyalty points that have been transferred from the account being viewed to the account of another registered user. "Transfer" status indicates loyalty points that have been transferred into the account being viewed from the account of another registered user. Further details concerning the process of transferring loyalty points is described below in connection with, for example, Figs. 26 and 48-51.

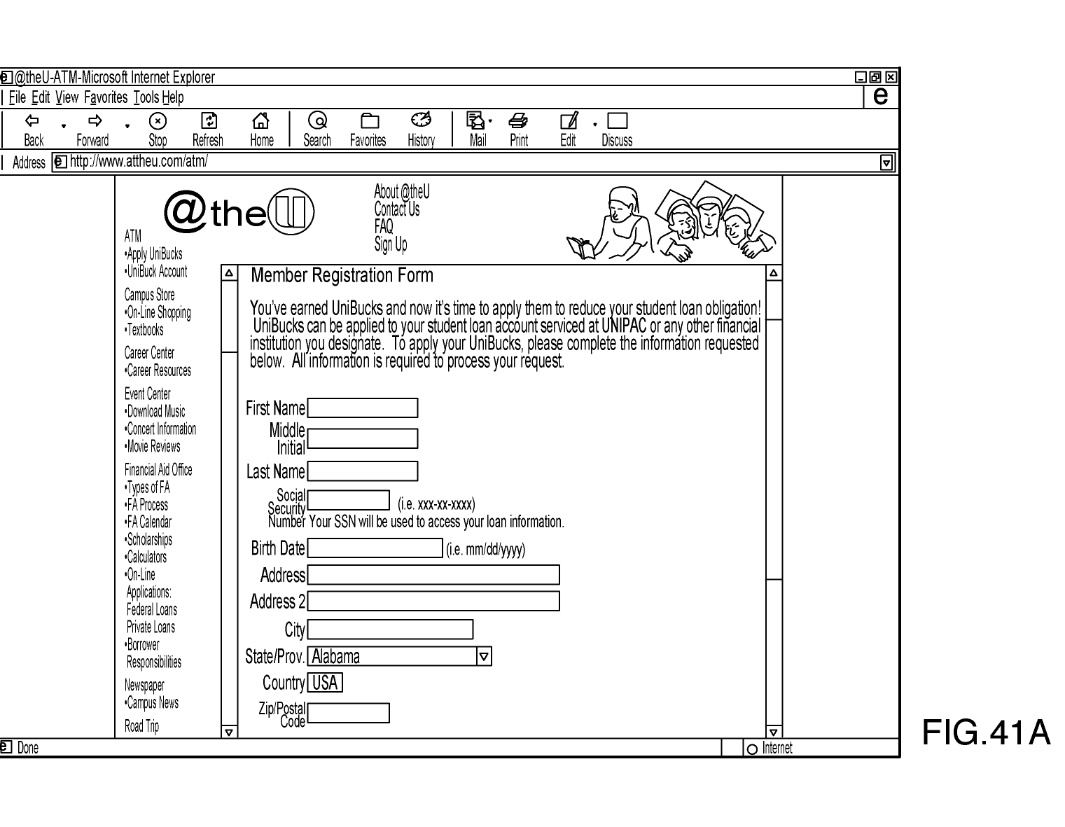

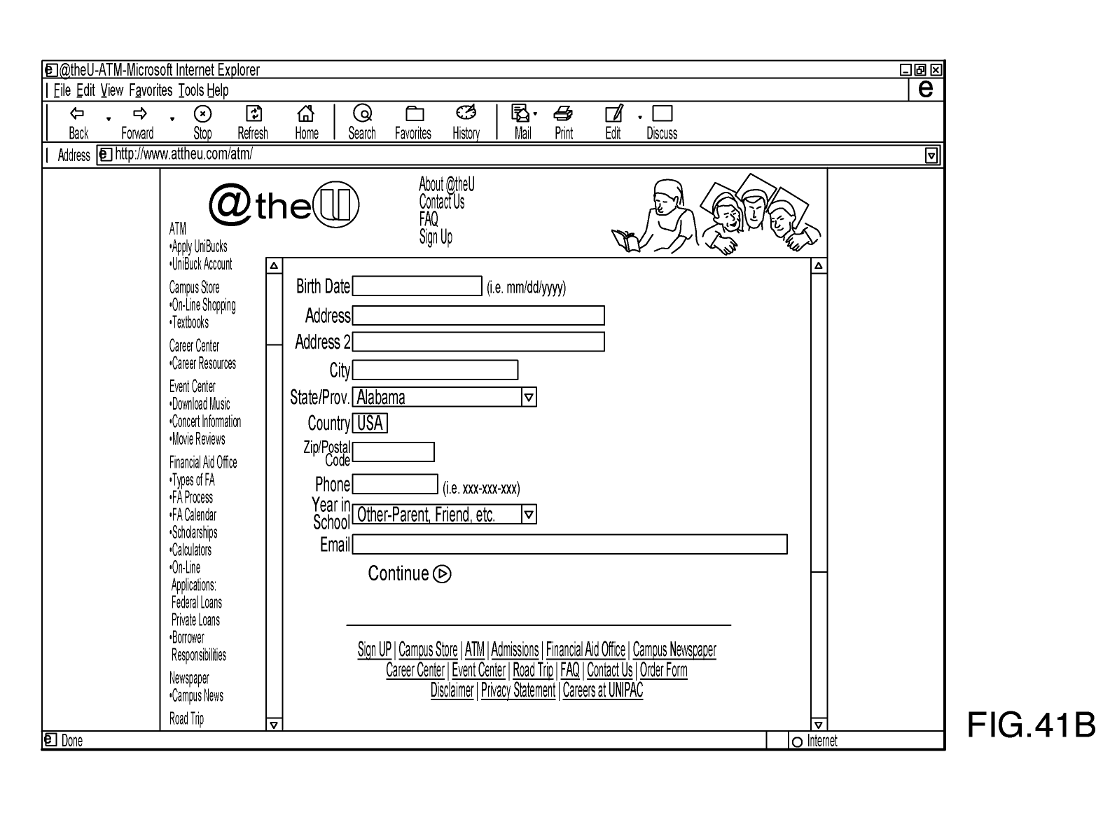

If, at block 1632 of Fig. 16, the user elects to view loan information for loans serviced by a primary loan servicer, they eventually will be shown more detailed information about all of their loans that are being serviced by the primary loan servicer. First, however, the system runs through the process represented by Fig.18. After block 1810, the system checks (block 1820) to see if the user is trying to view detailed account information for the first time. If it is the user's first attempt to view detailed account information, at block 1822 the user is required to complete a detailed registration. From Figs. 38 and 39, for example, a user may click on the "student loan account" hyperlink 72. When the user clicks on the "student loan account" hyperlink 72 for the first time, they are asked to complete a full member registration form like that depicted in Figs. 41A and 41B. The information requested during the detailed registration helps the primary loan servicer determine if it is servicing a loan for the registered member.

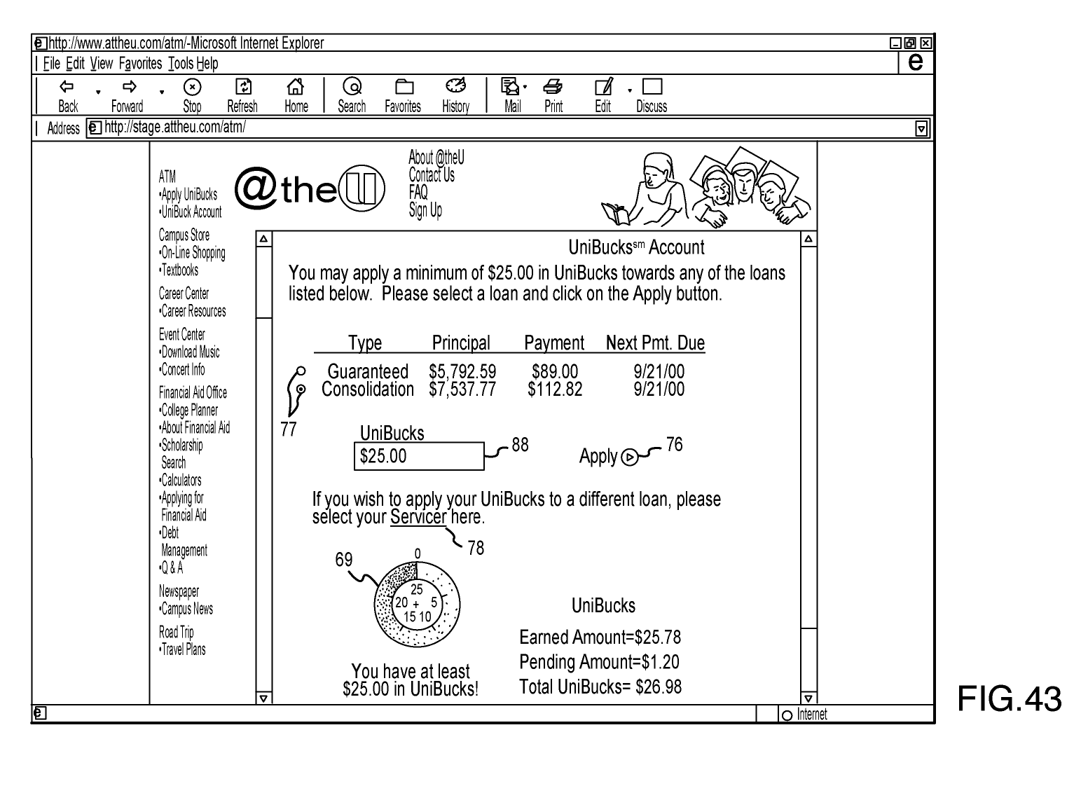

Once the registered member completes the full member registration form, any available student loan account information would be displayed to the member (block 1824 of Fig. 18). Fig. 42 is a sample screen of information displayed following completion of the full member registration form when a user has fewer than the minimum number of loyalty points that may be applied (twenty-five in the preferred embodiment) and when the user does not have any loans being serviced by the primary loan servicer. As shown in Fig. 42, no loan information is displayed, and the meter graphic indicates that the user has $6.42 in earned loyalty points. Fig. 43, on the other hand, is a sample screen that would be displayed for a user who completes the full member registration form (e.g., Figs. 41A and 41B) and has both a loan with the primary loan servicer and at least twenty-five earned loyalty points.

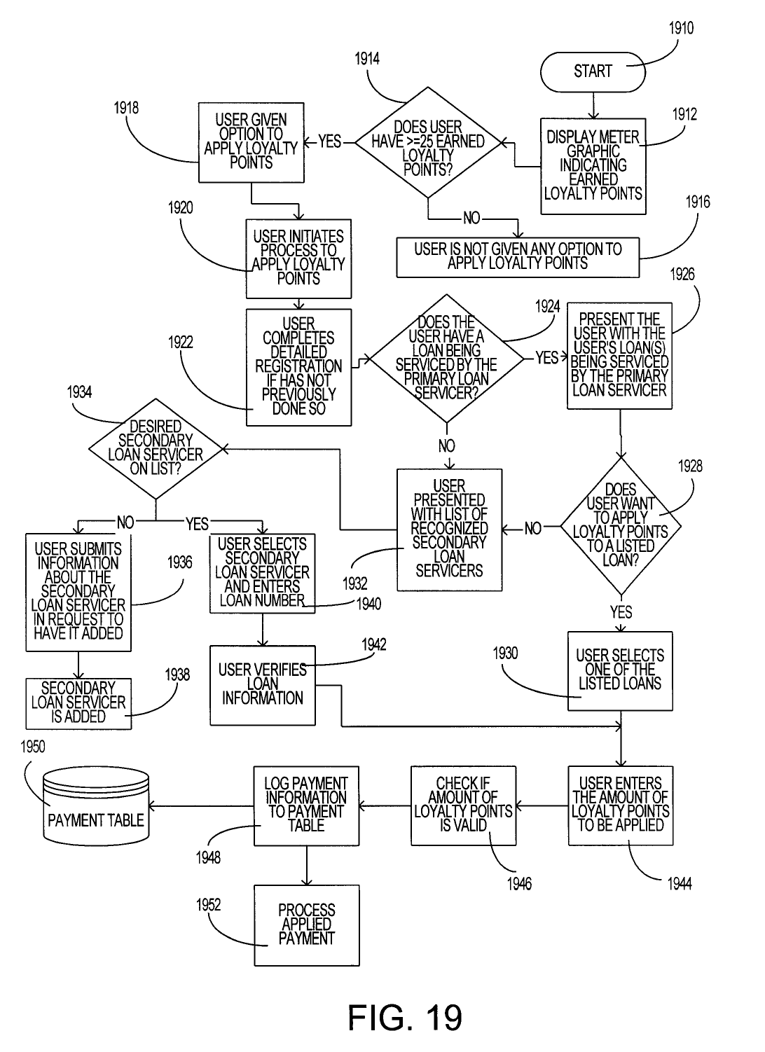

Referring again to Fig. 16, a third option for a user viewing either summary information about their loyalty point account (e.g., Fig. 39), detailed information about their account (e.g., Fig. 40), or information about their student loans (e.g., Fig. 43) is to "apply" their accumulated and earned loyalty points (block 1634). The process for applying accumulated and earned loyalty points is depicted in the flowchart of Fig. 19. The process of Fig.19 assumes that the user both has a loan and wants to "apply" loyalty points to reduce the balance of that loan.

Referring to Fig. 19, after block 1910, the system displays the meter graphic 69 (block 1912) indicating the number of earned loyalty points accumulated toward the minimum number required to be eligible to "apply" them (i.e., the first twenty-five in the preferred embodiment). Then, at block 1914, the system checks to see whether the user has at least twenty-five earned loyalty points. If the user does not have at least twenty-five earned loyalty points, at block 1916 the user is not given an option to apply loyalty points. For example, neither the "Click here to apply your UniBucks!" hyperlink 74 (Figs. 39 and 40) nor the "Apply" button 76 (Fig. 43) is presented to the user. This is readily apparent from comparing Fig. 39 ("Click here to apply your UniBucks!" hyperlink 74 present) to Fig. 38 ("Click here to apply your UniBucks!" hyperlink absent), or Fig. 43 ("Apply" button 76 present) to Fig. 42 ("Apply" button absent).

If, at block 1914, it is determined that the user has at least twenty-five "earned" loyalty points, the meter graphic 69 indicates that fact (see, e.g., Figs. 39, 40, and 43 where the meter graphic 69 shows twenty-five earned UniBucks), and the user is presented with the hyperlink 74 (Figs. 39 and 40) and the button 76 (Fig. 43) to apply loyalty points (block 1918) at appropriate points during the process. If, for example, the user is at the loyalty point manager page (Fig. 39) and initiates the process to apply loyalty points (block 1920 of Fig. 19) by clicking on the "Click here to apply your UniBucks!" hyperlink 74, the system checks whether the user has previously completed a detailed registration (block 1922). Similarly, and as a second example, if the user is reviewing detailed information related to the user's loyalty points account (Fig. 40) when the user elects to apply loyalty points (block 1920 of Fig. 19) by clicking on the "Click here to apply your UniBucks!" hyperlink 74', the system again checks whether the user has previously completed a detailed registration (block 1922). If the user has not completed the detailed registration process, the user is required to do so at block 1922. A user will have completed the detailed registration process if the user has previously viewed their loan information (see above discussion of Fig. 18) or has previously applied loyalty points to one or more loans. In either of these latter cases, the user is not required to complete another detailed registration process at block 1922.

At block 1924, the system has the information it requires to check whether the user has a loan being serviced by the primary loan servicer. If one or more such loans exist, at block 1926 the user is presented with information concerning those loans as shown in, for example, Fig. 43. For comparison, in Fig. 42 the user does not have any loans being serviced by the primary loan servicer, and, therefore, no loan information is presented under the loan information headers (Note that in Fig. 42, the user also has insufficient earned loyalty points to be eligible to apply them so the user is not given the option to apply loyalty points to a loan being serviced by a secondary loan servicer). If, at block 1928, the user elects to apply loyalty points to a loan being serviced by the primary loan servicer, at block 1930 the user selects a loan to which the loyalty points are to be applied. As shown in Fig. 43, the user preferably uses radio buttons 77 to select one of the displayed loans. In the preferred embodiment, when a user elects to apply loyalty points to a loan being serviced by the primary loan servicer, a 20 percent premium or bonus is simultaneously applied. In other words, whatever amount of loyalty points the user elects to apply is applied at 120 percent of the user-indicated amount. This may encourage users who need to incur additional loan obligations to seek lenders whose loans are serviced by the primary loan servicer.

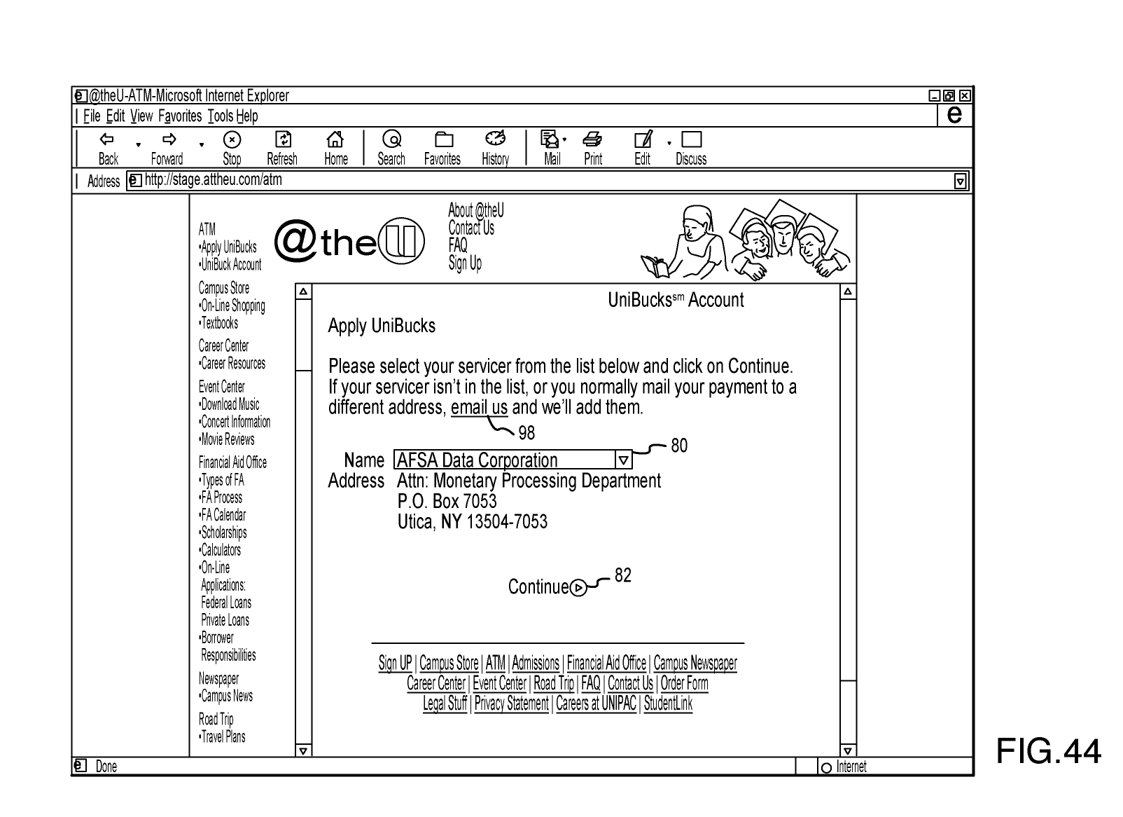

If the user elects to apply the loyalty points to a loan being serviced by a secondary loan servicer (the result of the inquiry of block 1924 or of block 1928 is "no"), the system then presents the user with a list of recognized secondary loan servicers from which to select (block 1932). In the preferred embodiment, the user so elects by clicking on the "Servicer" hyperlink 78 (see, e.g., Fig. 43), which causes the user's Web browser to display a page like the one shown in Fig. 44. In Fig. 44, a pop-up list of recognized loan servicers 80 is presented to the user. At block 1934 of Fig. 19, the user indicates to the system whether the desired secondary loan servicer is one of the displayed secondary loan servicers. If at block 1934 of Fig. 19, the desired secondary loan servicer is not on the displayed list of recognized secondary loan servicers, the user is given an option to submit information about the desired secondary loan servicer (block 1936). For example, a user could click on the "email us" hyperlink 98 depicted in Fig. 44 and email information concerning an unrecognized secondary loan servicer to the primary loan servicer. If a user provides information about a valid secondary loan servicer (i.e., a known student loan servicer in the preferred embodiment), the information concerning the new secondary loan servicer is manually added to the site for future selection by all users (block 1938). The user must revisit later to be able to select this newly-recognized secondary loan servicer.

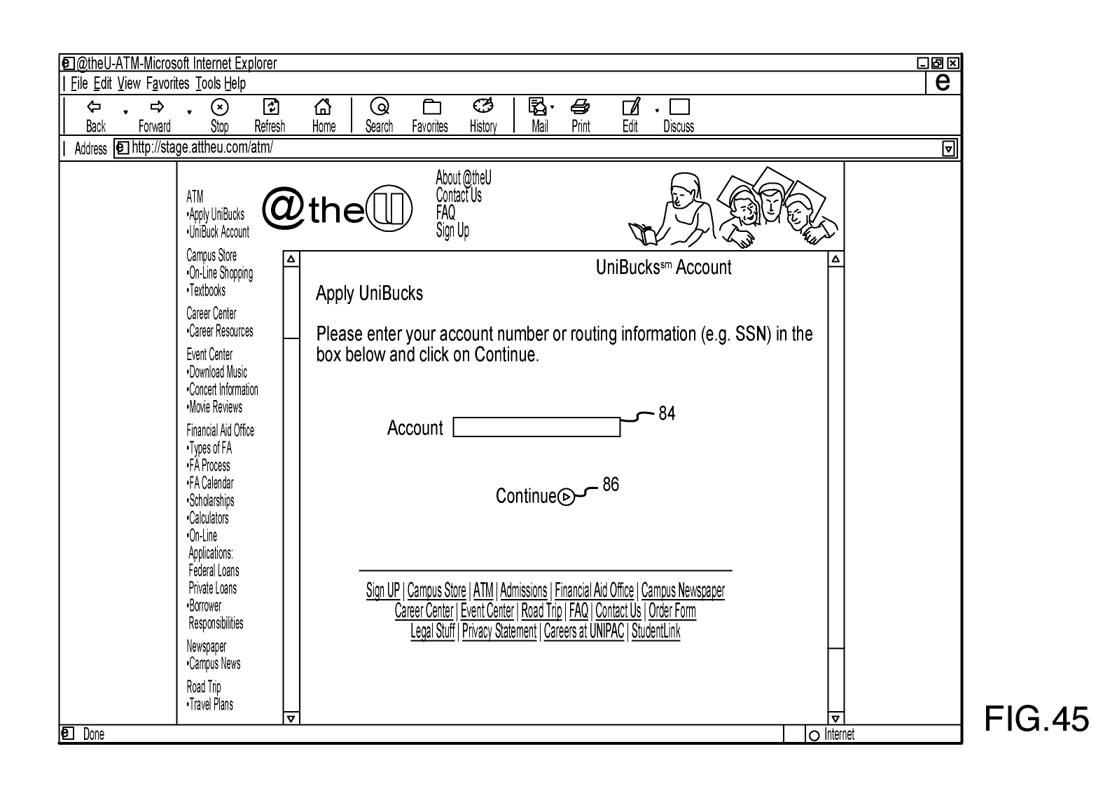

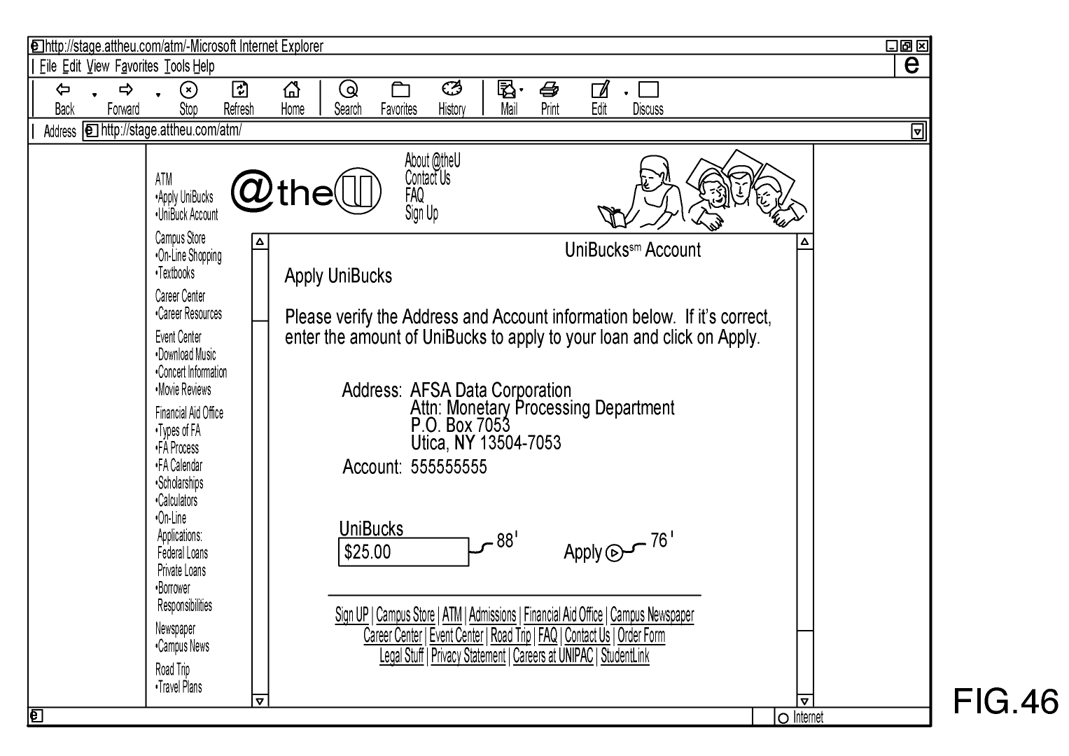

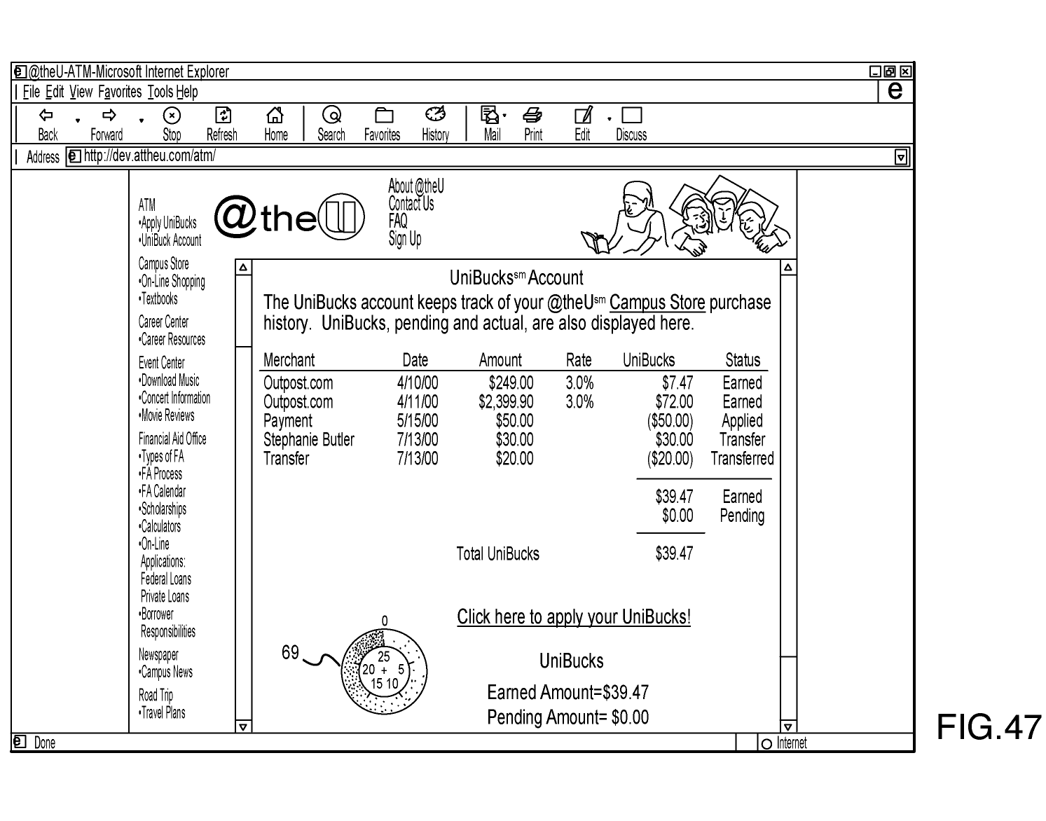

If, at block 1934, the desired secondary loan servicer (AFSA Data Corporation in Fig. 44) is on the list, the process continues at block 1940, where the user selects the appropriate secondary loan servicer from the displayed list. Also as part of block 1940 in Fig. 19, the user enters the appropriate account or loan number information for the selected secondary loan servicer. For example, by clicking on the "Continue" button 82 in Fig. 44, the user is given the opportunity to enter the appropriate account number in the text box 84 shown on, for example, Fig. 45. Once the user clicks on the "Continue" button 86 in Fig. 45, the user is given the opportunity to verify the selected loan information (block 1942 of Fig. 19). A sample screen shot of such an information verification page is shown in Fig. 46.

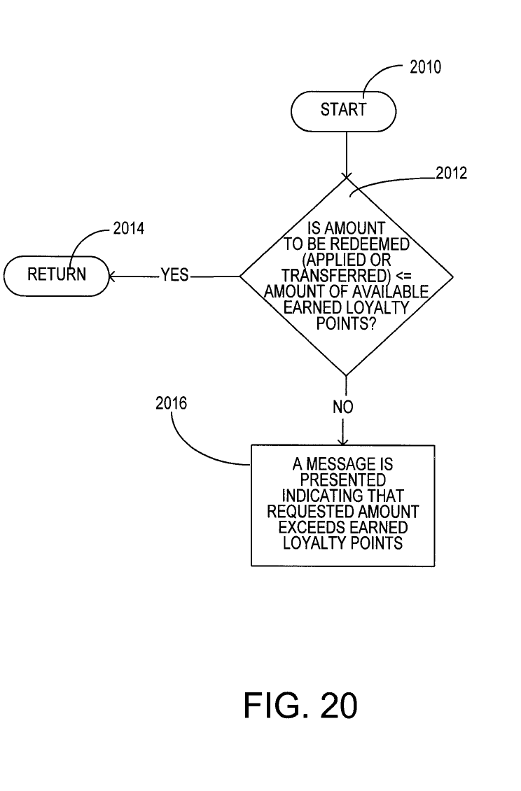

When the process gets to block 1944, the user has selected a particular loan being serviced by either the primary loan servicer (block 1930) or a secondary loan servicer (blocks 1940 and 1942). At block 1944, the user enters the amount of loyalty points that they want to apply to the selected loan. For example, in the text box 88 displayed in Fig. 43 (loan being serviced by the primary loan servicer) or in the text box 88' displayed in Fig. 46 (loan being serviced by a selected secondary loan servicer), the user enters the desired number of loyalty points to be applied. In the sample screens depicted in Fig. 43 and Fig. 46, the user has elected to apply twenty-five loyalty points (i.e., $25 of UniBucks) to the selected loan (see text box 88 in Fig. 43 and text box 88' in Fig. 46). After the user instructs the system to apply the indicated number of loyalty points, for example, by clicking on the "Apply" button 76 (Fig. 43) or 76' (Fig. 46), the system checks (block 1946) using the process displayed in Fig. 20 whether the amount of loyalty points a member desires to apply is an available amount.

Referring to Fig. 20, the process for checking whether the amount of loyalty points a member desires to apply is an available amount is discussed next. From block 2010, the system first checks at block 2012 whether the amount to be redeemed ("applied" in this case) is less than or equal to the total number of available (i.e., "earned") loyalty points. At block 1914 of Fig. 19, the system already checked whether the user had at least twenty-five earned loyalty points; thus, block 2012 of Fig. 20 need only check whether the user has at least as many earned loyalty points as the desired amount to be applied. If there are sufficient earned loyalty points available, at block 2014 of Fig. 20 the system returns to block 1946 of Fig. 19 to continue processing. Otherwise an error message is displayed at block 2016.

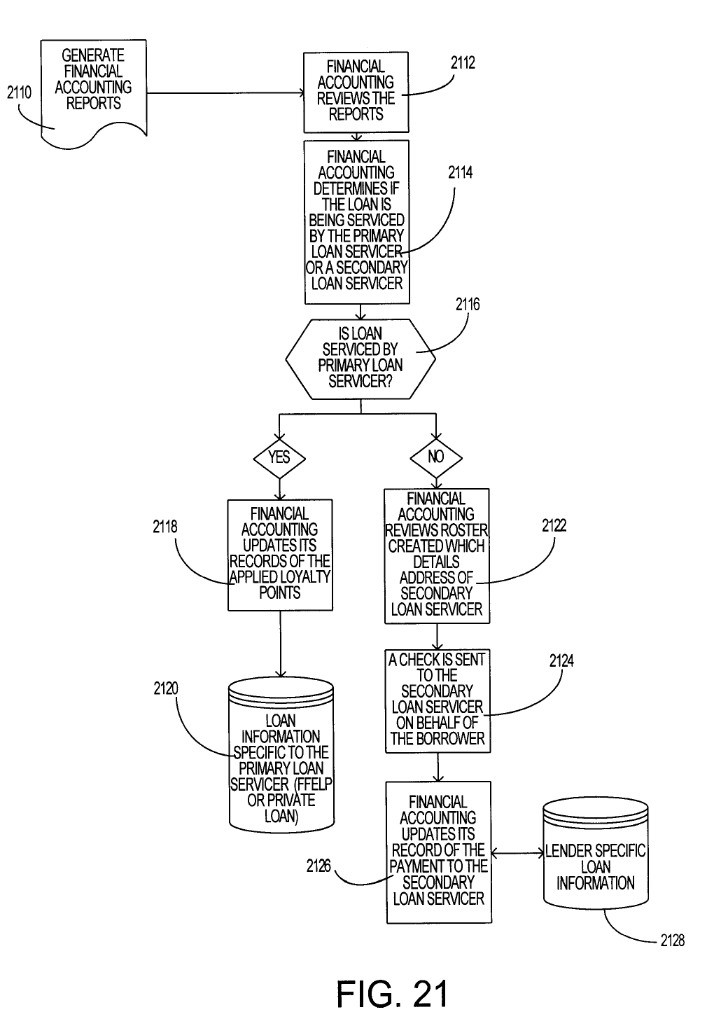

Returning to Fig. 19, after the number of loyalty points to be applied has been verified as being available using the process of Fig. 20, information regarding the payment is logged at block 1948 into a payment table 1950. The logged information may include, for example, the loan number, the amount of the payment (i.e., the loyalty points applied), and, if the loan is being serviced by a secondary loan servicer, the servicer's identification or name. At block 1952, the applied payment is processed as discussed next in connection with Figs. 21-24.

Referring next to Figs. 21-24, details concerning how the primary loan servicer processes an applied payment and further details concerning how accumulated loyalty points are tracked is described next. An applied payment is processed (see block 1952 of Fig. 19) according to the flowcharts presented in Figs. 21 and 22. At block 2110 of Fig. 21, financial accounting reports are generated according to the flowchart depicted in Fig. 22. As is shown in Fig. 22, information in the participant table, payments table, merchant table, and purchases table (block 2210) is used to generate the desired reports. For example, at block 2212 information concerning payments made to secondary loan servicers is selected from the tables on a nightly basis. Next, at block 2214, an application takes the selected payment information extracted from the tables and creates a spread sheet. At block 2216, the spread sheet is used to form a nightly report about payments made to secondary loan servicers.

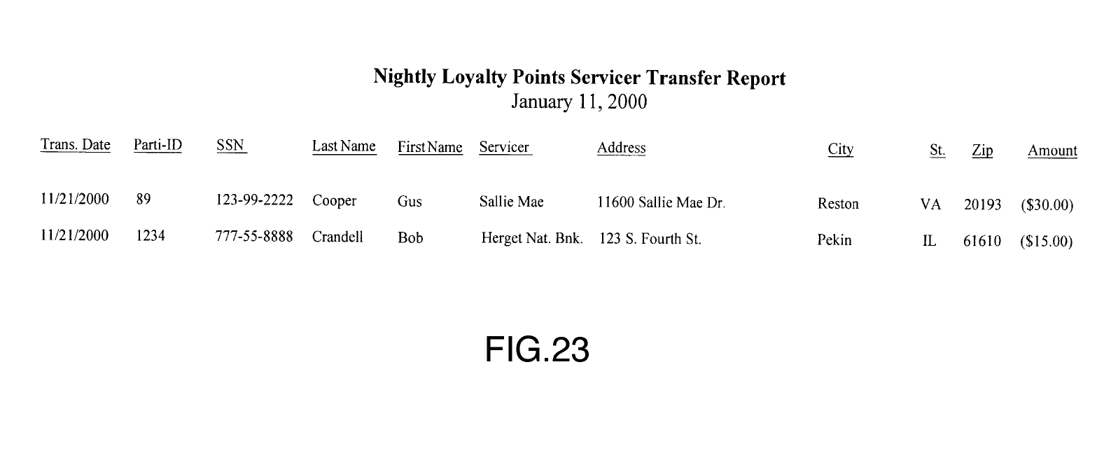

Fig. 23 is a sample nightly loyalty point servicer transfer report that may be generated at block 2216. The report shown in Fig. 23 lists information concerning the requests made by users during the day for payments to secondary loan servicers to be made by the primary loan servicer on behalf of the users. In the preferred embodiment, the indicated amount of the payment request equals, one-for-one, the number of applied loyalty points by the respective user. This report, in the preferred form shown in Fig. 23, provides the following eleven columns of information about payments to be made by the primary loan servicer on loans being serviced by secondary loan servicers: the date the user made the request ("Trans. Date"); the user's identifier ("Parti-ID"); the user's social security number ("SSN"); the user's last name ("Last Name"); the user's first name ("First Name"); the secondary loan servicer's name ("Servicer"); the secondary loan servicer's street address ("Address"), city ("City"), state ("St."), and zip code ("Zip"); and the amount of the payment to be made ("Amount").

Similarly, at block 2218 of Fig. 22, information is selected from the tables concerning loan payments made to the primary loan servicer on a nightly basis. At block 2220, an application takes that extracted information and creates a spread sheet from it. At block 2222, the spread sheet created in block 2220 is used to create a nightly report concerning payments made to loans being serviced by the primary loan servicer.

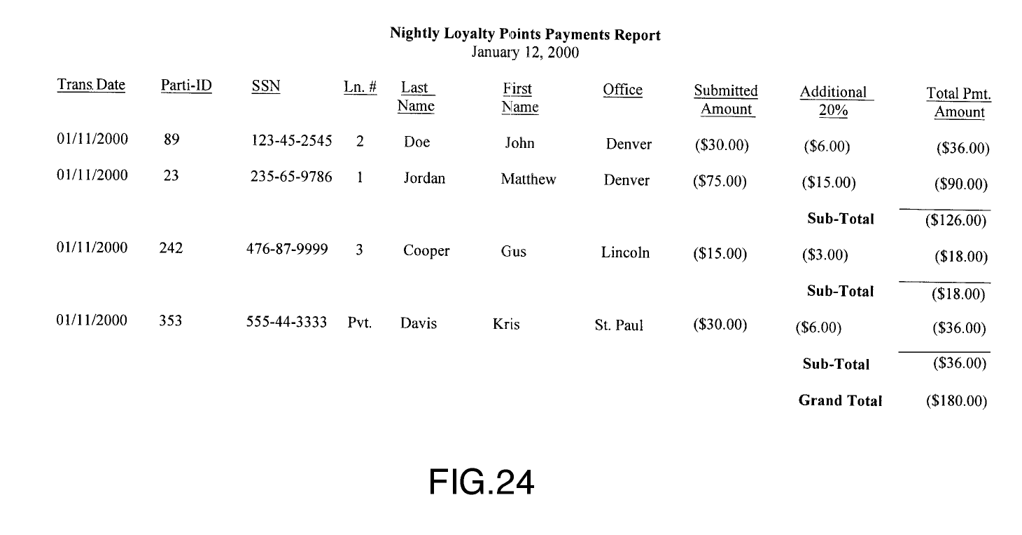

Fig. 24 is a sample nightly loyalty points payments report that may be generated at block 2222. This report, in the preferred form shown in Fig. 24, provides the following ten columns of information about requests for payments to be made on loans being serviced by the primary loan servicer: the date the user made the request ("Trans. Date"); the user's identifier ("Parti-ID"); the user's social security number ("SSN"); the loan number ("Ln. No."); the user's last name ("Last Name"); the user's first name ("First Name"); the office of the primary loan servicer primarily responsible for servicing the loan ("Office"); the actual amount of loyalty points submitted by the user ("Submitted Amount"); the premium amount of loyalty points that will also be applied ("Additional 20 percent"); and the total payment amount ("Total Pmt. Amount"). As also shown in Fig. 24, in this preferred format for the nightly loyalty points payments report, the displayed information is presented by office of the primary loan servicer primarily responsible for the loans.

Fig. 22 also shows the generation of a monthly report used in tracking accumulated loyalty points. In block 2224, information concerning purchases made for a given month is extracted from the tables shown in block 2210, including the purchases table which was updated as discussed above in connection with Fig. 17. At block 2226, an application takes the extracted information concerning purchases for a given month and creates a spread sheet. At block 2228, the information contained in this spread sheet is used to create a monthly report concerning purchases.

Fig. 25 is a sample monthly loyalty points earned report that may be generated at block 2228, and which provides information concerning commissions earned by purchases at various merchants. For example, the report shown in Fig. 25 provides the following seven columns of information: the transaction date ("Trans. Date"); the user's identifier ("Parti-ID"); the merchant identifier ("Merchant ID"); the purchase amount ("Purch. Amount"); the user's portion of the commission ("Borr. Comm."); the primary loan servicer's portion of the commission ("Unipac Rev."); and the total commission paid ("Total Comm.").

At block 2230, the reports generated in blocks 2216, 2222, and 2228 are sent to the financial accounting department of the primary loan servicer. In the preferred embodiment, these reports are communicated electronically to the financial accounting department where they are used to update loan and loyalty point information for the registered members. The updating of loan information is further discussed next. Finally, at block 2232, the system returns to block 2110 of Fig. 21.

Referring again to Fig. 21, at block 2112, the financial accounting department reviews the various reports that it has received. From those reports, at block 2114, the financial accounting department determines if a loan is being serviced by the primary loan servicer or a secondary loan servicer. In the most preferred embodiment, the reports (block 2110 and Fig. 22) are automatically split out by primary loan servicer and secondary loan servicers. If the loan is being serviced by the primary loan servicer, at block 2118, the financial accounting department of the primary loan servicer updates its records 2120 to reflect the applied loyalty points. In the preferred embodiment, the primary loan servicer applies loyalty points to reduce the principal balance of a loan without affecting the existing scheduled repayment plan. If, on the other hand, at blocks 2114 and 2116, it is determined that the loan is being serviced by a secondary loan servicer, at block 2122 the financial accounting department reviews the roster of secondary loan servicers. The roster includes name and address information for the various secondary loan servicers. At block 2124, the financial accounting department sends a check to the secondary loan servicer on behalf of the borrower. At block 2126, the financial accounting department updates its records 2128 of the payment to the secondary loan servicer.

Obviously, the result of applying loyalty points to a loan being serviced by a secondary loan servicer may vary depending upon the policies of the secondary loan servicer. For example, if a loyalty point payment is less than the amount of the next scheduled payment due on the loan, the secondary loan servicer may apply the loyalty points as a partial payment of that next scheduled payment, with the balance of that payment remaining due on or before the next scheduled payment due date. If the loyalty point payment is equal to the amount of the next scheduled payment due on the loan, the secondary loan servicer may apply the loyalty points as the loan payment. If the loyalty point payment is more than the amount of the next scheduled payment due on the loan, the secondary loan servicer may apply the loyalty point payment to either reduce the principal owing on the loan or as a partial advance payment of the next following scheduled payment due on the loan. Finally, the secondary loan servicer may apply the entire loyalty point payment to reduce principal without interrupting the existing scheduled repayment plan.

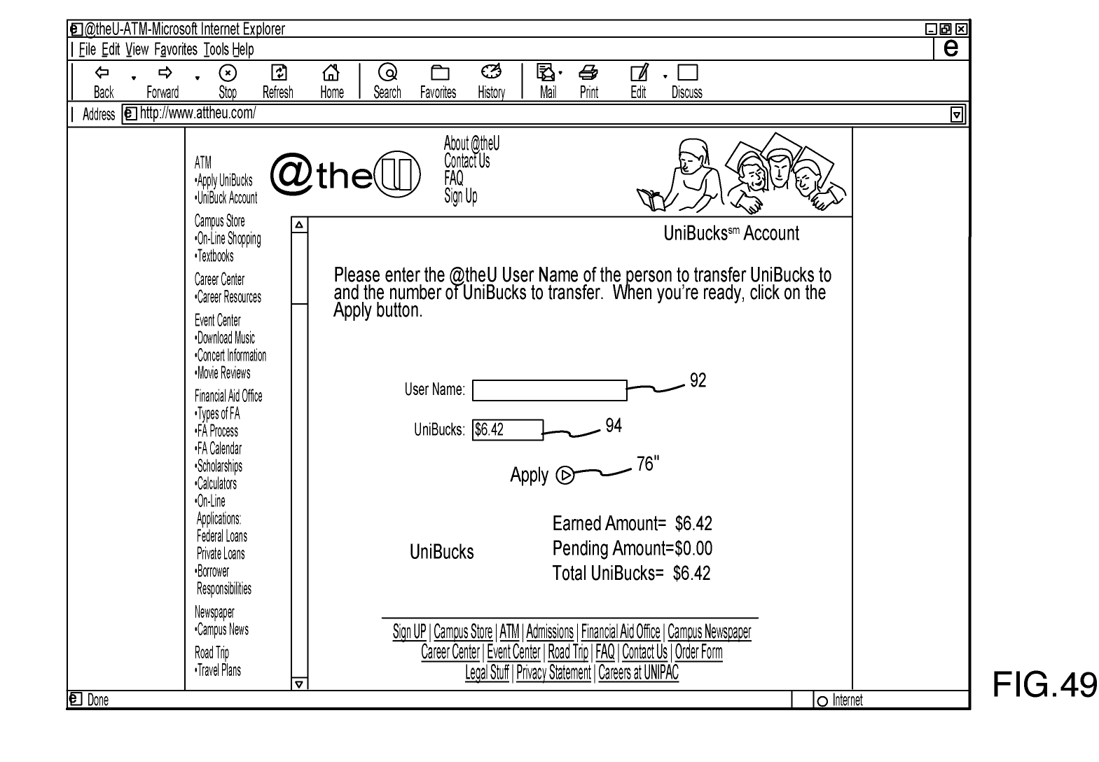

Referring back to Fig. 16, the fourth option that users viewing their summary loyalty point account information (Figs. 38 and 39) may pursue is to transfer earned loyalty points (block 1636) to build the available loyalty points account balance of another registered member. For example, individuals who do not have any pertinent loan obligations may earn loyalty points and transfer them to one or more registered members who do have pertinent present loan obligations or who expect to have a pertinent future loan obligation. Registered users who click on the "transfer" hyperlink 96 are taken to a screen (see, e.g., Fig. 49) where they can initiate loyalty point transfers. As shown by block 1642 of Fig. 16, the process for transferring loyalty points to another registered member is shown in Fig. 26. To transfer loyalty points between registered members, after block 2610 of Fig. 26, the system checks whether the user has any earned loyalty points (block 2612). In the preferred embodiment, there is no minimum number of earned loyalty points that a user must accumulate before that user may transfer loyalty points to another registered member.

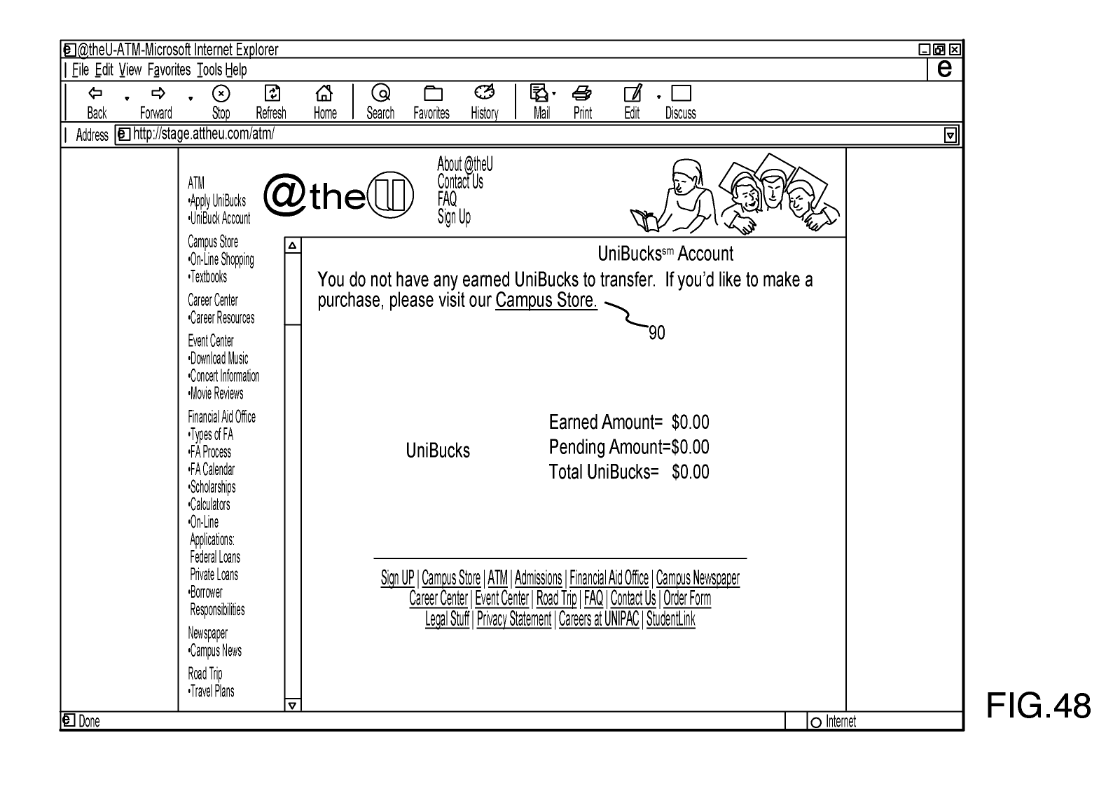

If the user does not have any earned loyalty points, at block 2614 a message is presented indicating that the user does not have any earned loyalty points, and a link to the Campus Store is provided. For example, Fig. 48 is a screen shot showing the message displayed when a user tried to transfer loyalty points without having any earned loyalty points. As shown in Fig. 48, a hyperlink 90 to the Campus Store is provided along with a statement that the user did not have any earned loyalty points to transfer.

If, on the other hand, the user does have earned loyalty points, from block 2612, the process advances to block 2616 where the system requests information regarding the transfer candidate (i.e., the person to whom the user wants to transfer earned loyalty points). Fig. 49, for example, is a screen shot with a pair of text boxes 92, 94 to be completed by the transferring user. In the first text box 92, the user enters the user name of the person to whom the earned loyalty points are to be transferred, and in the second text box 94, the user enters the number of earned loyalty points to be transferred. The amount entered in the second text box 94 must be less than or equal to the total number of earned loyalty points. In Fig. 49, for example, there are $6.42 of available earned loyalty points, and the user has entered this amount in text box 94 as the transfer amount.

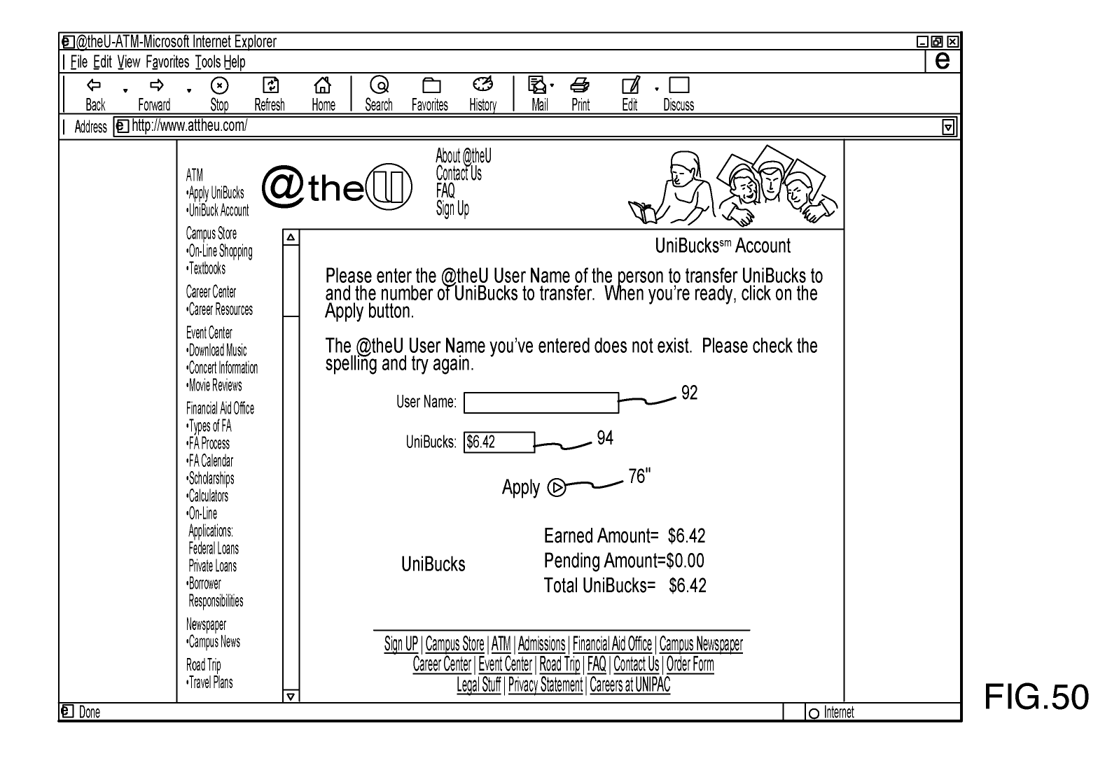

At block 2618, the user has requested that the transfer of loyalty points be executed (e.g., by clicking on the "Apply" button 76'' shown in Fig. 49), so the system first checks whether the transfer candidate is a registered member. If the candidate is not a registered member, at block 2620 a message is displayed indicating that the member identification entered does not exist, and the system returns to block 2616, where it waits for information concerning a valid transfer candidate (see, e.g., Fig. 50). If, at block 2618, the system determines that the transfer candidate is a registered member, at block 2622, the system checks whether the amount to be transferred is a valid amount. To check whether the amount of loyalty points to be transferred is a valid amount, the flowchart of Fig. 20 is again used.

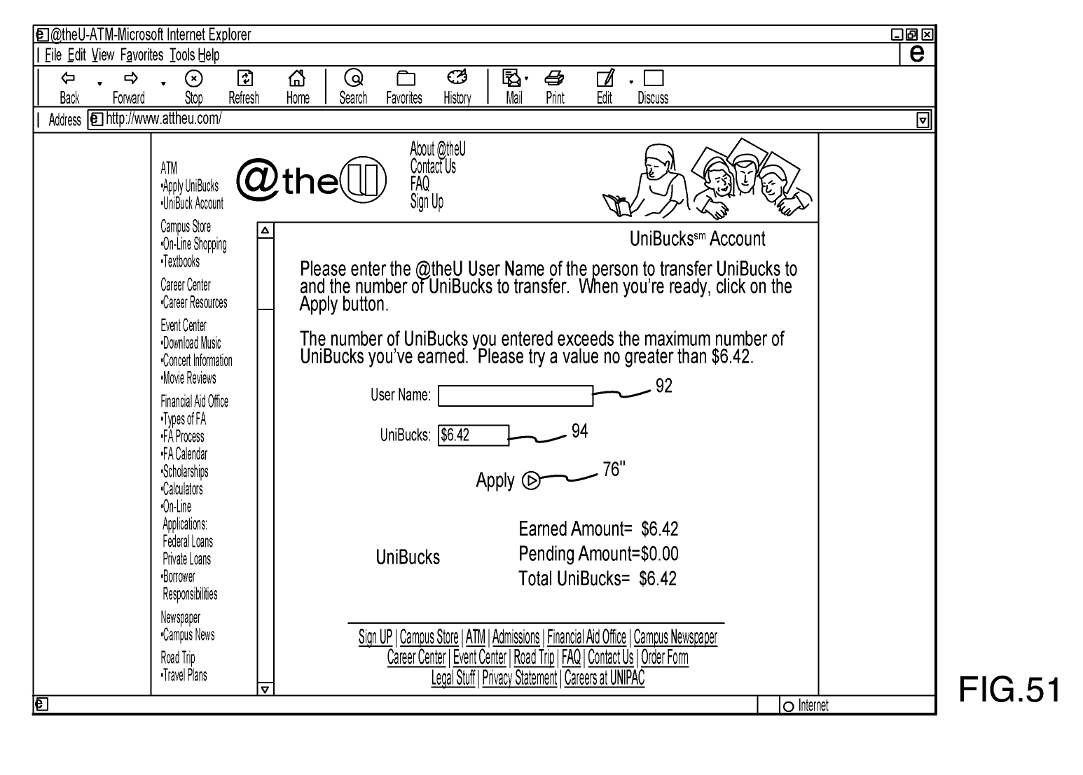

Referring to Fig. 20, from block 2010, the system determines at block 2012 whether the amount to be redeemed (i.e., "transferred" in this case) is no more than the number of available (i.e., "earned") loyalty points. If the amount of loyalty points to be transferred is no more than the number of earned loyalty points, at block 2014 the system returns to block 2622 of Fig. 26, from which processing would continue to block 2624. If, however, at block 2012 of Fig. 20, the system determines that the amount of loyalty points which a user desires to transfer is greater than the amount of available earned loyalty points, at block 2016 a message is presented indicating that the requested amount of loyalty points exceeds earned loyalty points, and the system returns to block 2622 of Fig. 26, from which processing would continue to block 2616, where the system waits for a valid transfer amount. If a user attempts to transfer more loyalty points than they have available, a screen like that depicted in Fig. 51 may be presented to the user. As shown in Fig. 51, the user is informed that the number of loyalty points that the user sought to transfer exceeded the maximum number of earned loyalty points available to that user. To successfully complete a transfer, the user would need to enter an acceptable amount in box 94 and re-select the "Apply" button 76''.

Returning to Fig. 26, if at block 2622, the amount to be transferred checks out as valid, at block 2624, information concerning the transfer is logged in a transfers table 2626. The logged information may include, for example, the amount of loyalty points to be deducted from the transferor's account and added to the transferee's account.

Although the preferred embodiments of this invention have been described above with a certain degree of particularity, those skilled in the art could make numerous alterations to the disclosed embodiments without departing from the spirit or scope of this invention. For example, although in the most preferred embodiment of the invention, the loan being repaid is a student loan, the method is applicable to any type of loan including consumer loans and real estate loans. Also, loyalty points need not be applied as soon as the member's account balance reaches a predetermined amount, because, in the preferred embodiment, the loyalty points do not expire if not used within a certain amount of time. Since loyalty points preferably do not expire, members may accumulate loyalty points to be applied to a later-incurred loan. A time limit could, however, be set for using loyalty points at the risk of losing them without departing from the spirit and scope of this invention. It is intended that all matter contained in the above description or shown in the accompanying drawings shall be interpreted as illustrative only and not limiting. Changes in details may be made without departing from the spirit of the invention as defined in the appended claims.

Claims

1. A method of accumulating and redeeming loyalty points, said method comprising the steps of
(A) establishing a site on a global computer network;
(B) recognizing at least certain users of said site;
(C) directing said recognized users to merchants;
(D) enabling accumulation of loyalty points by said recognized users based upon purchases from said merchants;
(E) monitoring said purchases by said recognized users from said merchants;
(F) tracking said accumulated loyalty points; and
(G) permitting selective redemption of said accumulated loyalty points.

2. The method of claim 1, wherein said step (D) further comprises enabling accumulation of loyalty points based upon a commission rate for each of said merchants, and wherein said method further comprises the step of permitting said recognized users to look up said commission rates.

3. The method of claim 1, wherein said site established in said step (A) is a virtual college community, with topics primarily of interest to past, present, and future college students.

4. The method of claim 1, wherein said recognized users include a first user, and wherein said step (G) further comprises permitting application of said selectively redeemed loyalty points to an outstanding balance of a loan obligation of said first user to permit repayment of said loan obligation using said applied loyalty points.

5. The method of claim 4, wherein said step (G) further comprises requiring that said first user apply at least a predetermined minimum number of loyalty points.

6. The method of claim 5, wherein said minimum number of loyalty points is twenty-five loyalty points.

7. The method of claim 1, wherein said recognized users include a first user and a second user, and wherein said step (G) further comprises transferring said selectively redeemed loyalty points from said first user to said second user.

8. A method of facilitating repayment of a loan obligation, said method comprising the steps of
(A) establishing a site on a global computer network;
(B) recognizing at least certain users of said site by requiring said certain users to provide initial registration information;
(C) directing said recognized users to predetermined merchants;
(D) enabling accumulation of loyalty points by said recognized users based upon purchases from said predetermined merchants;
(E) monitoring said purchases by said recognized users from said predetermined merchants; and
(F) tracking said accumulated loyalty points.

9. The method of claim 8, wherein said step (F) further comprises automatically tracking said accumulated loyalty points.

10. The method of claim 8, wherein said step (B) further comprises storing said initial registration information in a participant table.

11. The method of claim 8, wherein said initial registration information comprises
an email address;
a user name; and
a password.

12. The method of claim 8, wherein said step (C) further comprises presenting said recognized users with a first selectable button to link said recognized users to a virtual shopping mall and a second selectable button to link said recognized users to a preferred textbook merchant, wherein said step (E) further comprises monitoring a first one of said recognized users for selection of one of said first and second selectable buttons, and wherein, following selection of one of said first and second selectable buttons, said step (E) further comprises requiring said first one of said recognized users to log in.

13. The method of claim 12, wherein said step (E) further comprises
checking a login status of said first one of said recognized users; and
presenting said first one of said recognized users with a login screen if said checking step determines that said first one of said recognized users is not logged in.

14. The method of claim 13, wherein said initial registration information comprises a user name and a password, and wherein said login screen requires said first one of said recognized users to enter said user name and said password.

15. The method of claim 12, wherein said step (F) further comprises passing identifying information about said first one of said recognized users to a selected merchant selected by said first one of said recognized users.

16. The method of claim 15, wherein said step (B) further comprises assigning a member ID to said first one of said recognized users.

17. The method of claim 16, wherein said identifying information comprises said member ID, and wherein said step (E) further comprises passing said member ID to said selected merchant.

18. The method of claim 17, wherein said step (F) further comprises said selected merchant filling an order, creating a transaction record comprising information about said filled order, and posting said transaction record to an information retrieval system.

19. The method of claim 17, wherein said step (F) further comprises said selected merchant filling an order, creating a transaction record comprising information about said filled order, and transmitting said transaction record to a merchant broker.

20. The method of claim 19, wherein said merchant broker posts said transaction record to an information retrieval system.

21. The method of claim 20, wherein said step (D) further comprises said merchant broker assigning merchant identification numbers to said predetermined merchants and prearranging a commission structure with said predetermined merchants, whereby said purchases by said recognized users from said predetermined merchants produce an accumulation of loyalty points according to said prearranged commission structure, and wherein said transaction record includes raw sales and commission data.

22. The method of claim 18 or 20, wherein said step (D) further comprises prearranging a commission structure with said predetermined merchants, whereby said purchases by said recognized users from said predetermined merchants produce an accumulation of loyalty points according to said prearranged commission structure, and further wherein said transaction record includes raw sales and commission data.

23. The method of claim 22, wherein said step (A) further comprises a primary loan servicer establishing said site on said global computer network, and wherein said step (F) further comprises said primary loan servicer
(i) requesting said transaction record;
(ii) receiving said transaction record; and
(iii) logging said transaction record in a purchase table.

24. The method of claim 23, wherein said step (i) is performed manually, and wherein said step (ii) further comprises receiving said transaction records electronically on a weekly basis.

25. The method of claim 23, wherein said step (F) further comprises said primary loan servicer further processing said raw sales and commission data to determine a number of loyalty points accumulated by said first one of said recognized users based upon said commission structure.

26. The method of claim 25, wherein, for each of said predetermined merchants, said commission structure includes at least one product and a full commission for said at least one product, and wherein said number of loyalty points accumulated by said first one of said recognized users for purchasing said at least one product equals no more than said full commission.

27. The method of claim 19, wherein said merchant broker provides marketing resources and data about said predetermined merchants.

28. The method of claim 27, wherein said step (A) further comprises a primary loan servicer establishing said site on said global computer network, and wherein said step (C) further comprises said primary loan servicer incorporating said marketing and resource data into said site for presentation to said recognized users.

29. The method of claim 8, further comprising the steps of
(G) requiring said recognized users to provide additional registration information; and
(H) permitting said recognized users who provide said additional registration information to selectively repay the loan obligation based upon discretionary redemption of said accumulated loyalty points.

30. The method of claim 8, wherein said recognized users include a first recognized user and a second recognized user, said method further comprising the steps of
(G) requiring said first recognized user to provide additional registration information; and
(H) permitting said first recognized user to selectively transfer loyalty points to said second recognized user based upon discretionary redemption of said accumulated loyalty points.

31. The method of claim 30, further comprising the step of permitting said first recognized user to selectively repay the loan obligation based upon discretionary redemption of said accumulated loyalty points.

32. The method of claim 29, 30, or 31, wherein said additional registration information comprises
a name;
a social security number;
a birth date;
an address; and
a telephone number.

33. The method of claim 29, 30, or 31, wherein said step (D) further comprises prearranging a commission structure with said predetermined merchants, whereby said purchases by said recognized users from said predetermined merchants produce an accumulation of loyalty points according to said prearranged commission structure.

34. The method of claim 29, 30, or 31, wherein said step (D) further comprises enabling accumulation of loyalty points at a predetermined percentage of a purchase price, wherein said predetermined percentage varies by merchant based upon prearranged merchant agreements.

35. The method of claim 34, wherein said predetermined percentage is no more than 5 percent of said purchase price.

36. The method of claim 8, wherein said step (C) further comprises presenting said recognized users with a selectable button to link said recognized users to a virtual shopping mall.

37. The method of claim 36, wherein said virtual shopping mall comprises a list of said predetermined merchants.

38. The method of claim 8, wherein said step (C) further comprises presenting said recognized users with a list of said predetermined merchants.

39. The method of claim 37 or 38, wherein said list of said predetermined merchants is presented alphabetically.

40. The method of claim 37 or 38, wherein said list of said predetermined merchants is presented based upon a user-selectable category from a list of available categories.

41. The method of claim 40, wherein said list of available categories is presented as a pop-up list of available categories.

42. The method of claim 37 or 38, wherein at least one of said predetermined merchants has a merchant site on said global computer network, and wherein said step (C) further comprises framing screens from said merchant site of said at least one predetermined merchant.

43. The method of claim 37 or 38, wherein at least one of said predetermined merchants has a merchant site on said global computer network, and wherein said step (C) further comprises hyperlinking to said merchant site of said at least one of said predetermined merchants.

44. The method of claim 8, wherein said step (C) further comprises directing said recognized users to at least one predetermined textbook merchant.

45. The method of claim 8, wherein said step (A) further comprises establishing said site on said global computer network to include linkable references to a preferred textbook merchant, and wherein said step (C) further comprises directing said recognized users to said preferred textbook merchant.

46. The method of claim 45, wherein said step (C) further comprises presenting said recognized users with a user-selectable button to link said recognized users to said preferred textbook merchant.

47. A method of facilitating repayment of a loan obligation, said method comprising the steps of
(A) establishing a site on a global computer network;
(B) recognizing at least certain users of said site by requiring said certain users to provide initial registration information, wherein said recognized users include a first recognized user and a second recognized user;
(C) requiring said first recognized user to provide additional registration information;
(D) directing said recognized users to predetermined merchants;
(E) enabling accumulation of loyalty points by said recognized users based upon purchases from said predetermined merchants;
(F) monitoring said purchases by said recognized users from said predetermined merchants;
(G) tracking said accumulated loyalty points; and
(H) permitting selective application of said accumulated loyalty points to at least one loan of said first recognized user.

48. The method of claim 47, wherein said step (A) further comprises a primary loan servicer establishing said site on said global computer network, and wherein said method further comprises the step of
(I) displaying to said first recognized user loan information about at least one loan of said first recognized user that is being serviced by the primary loan servicer.

49. The method of claim 48, wherein said displayed loan information comprises
(i) loan type;
(ii) principal remaining;
(iii) payment amount; and
(iv) next payment due date.

50. The method of claim 48, wherein said step (H) further comprises
(i) displaying a selectable radio button adjacent to said displayed loan information about said at least one loan of said first recognized user that is being serviced by the primary loan servicer;
(ii) displaying a numerical entry box in which said first recognized user can type a number of accumulated loyalty points to be applied to a selected one of said at least one loan of said first recognized user that is being serviced by the primary loan servicer; and
(iii) applying said typed number of accumulated loyalty points to said selected one of said at least one loan of said first recognized user on an at least one-loyalty-point-for-one-dollar basis.

51. The method of claim 50, wherein said step (H) further comprises applying 120 percent of said typed number of accumulated loyalty points to said selected one of said at least one loan of said first recognized user.

52. The method of claim 47, wherein said step (H) further comprises
(i) displaying a user-selectable list of secondary loan servicers from which said first recognized user can select a desired secondary loan servicer;
(ii) displaying a text entry box in which said first recognized user can type a loan identifier of a selected loan being serviced by said selected secondary loan servicer;
(iii) displaying a numerical entry box in which said first recognized user can type a number of accumulated loyalty points to be applied to said selected loan being serviced by said selected secondary loan servicer; and
(iv) applying said typed number of accumulated loyalty points to said selected loan of said first recognized user.

53. The method of claim 52, wherein said step (H) further comprises transferring funds to said selected secondary loan servicer on an at least one-loyalty-point-for-one-dollar basis.

54. A method of facilitating repayment of a loan obligation, said method comprising the steps of
(A) establishing a site on a global computer network;
(B) recognizing at least certain users of said site by requiring said certain users to provide initial registration information, wherein said recognized users include a first recognized user and a second recognized user;
(C) requiring said first recognized user to provide additional registration information;
(D) directing said recognized users to merchants;
(E) enabling accumulation of loyalty points by said recognized users based upon purchases from said merchants;
(F) monitoring said purchases by said recognized users from said merchants;
(G) tracking said accumulated loyalty points; and
(H) displaying information about said accumulated loyalty points to said first recognized user.

55. The method of claim 54, wherein said step (H) further comprises
categorizing a first number of said accumulated loyalty points with a first status of "pending," and categorizing a second number of said accumulated loyalty points with a second status of "earned," wherein said first number and said second number together sum to a total number of said accumulated loyalty points; and
displaying said first number, said second number, and said total number of said accumulated loyalty points.

56. The method of claim 55, wherein said categorizing step further comprises placing all newly accumulated loyalty points in said first status for a predetermined status waiting period and then changing said accumulated loyalty points to said second status after said status waiting period elapses.

57. The method of claim 56, wherein said status waiting period is 30 days.

58. The method of claim 55 or 56, wherein said displaying step further comprises graphically presenting said second number of said accumulated loyalty points using a meter graphic.

59. The method of claim 58, wherein said method further comprises the step of permitting said first recognized user to selectively redeem said accumulated loyalty points having said second status in a redemption amount no greater than said second number of said accumulated loyalty points.

60. The method of claim 59, wherein said permitting step further comprises requiring that said first recognized user selectively redeem at least a minimum number of said accumulated loyalty points.

61. The method of claim 60, wherein said displaying step further comprises graphically presenting said second number of said accumulated loyalty points as a portion of said minimum number of said accumulated loyalty points.

62. The method of claim 61, wherein said minimum number of loyalty points is twenty-five loyalty points.

63. The method of claim 59, wherein said first recognized user selectively redeems said accumulated loyalty points in one of the following two ways:
(1) by applying said selectively redeemed loyalty points to an outstanding balance of a loan obligation of said first user to permit repayment of said loan obligation using said applied loyalty points; and
(2) by transferring said selectively redeemed loyalty points to said second recognized user.

64. The method of claim 63, wherein said first recognized user must apply at least a minimum number of said accumulated loyalty points, and may transfer any number of said accumulated loyalty points.

65. A method of facilitating repayment of a loan obligation, said method comprising the steps of
(A) establishing a site on a global computer network;
(B) recognizing at least certain users of said site by requiring said certain users to provide initial registration information, wherein said recognized users include a first recognized user and a second recognized user;
(C) requiring said first recognized user to provide additional registration information;
(D) directing said recognized users to predetermined merchants;
(E) enabling accumulation of loyalty points by said recognized users based upon purchases from said predetermined merchants;
(F) monitoring said purchases by said recognized users from said predetermined merchants;
(G) tracking said accumulated loyalty points;
(H) categorizing a first number of said accumulated loyalty points of said first recognized user with a first status of "pending," and categorizing a second number of said accumulated loyalty points of said first recognized user with a second status of "earned";
(I) permitting said first recognized user to selectively redeem said accumulated loyalty points having said second status in a first redemption amount no greater than said second number of said accumulated loyalty points, wherein said first recognized user selectively redeems said accumulated loyalty points in one of the following two ways:
(1) by applying said selectively redeemed loyalty points to an outstanding balance of a loan obligation of said first recognized user to permit repayment of said loan obligation using said applied loyalty points; and
(2) by transferring said selectively redeemed loyalty points to said second recognized user;
and
(J) displaying loyalty points information to said first recognized user, wherein said displayed information includes said first number, said second number, and said first redemption amount.

66. The method of claim 65, wherein said step (J) further comprises displaying details concerning said accumulated loyalty points, wherein, for each purchase from one of said predetermined merchants, said details include
(1) a merchant name;
(2) a transaction date;
(3) a purchase amount;
(4) a rate at which loyalty points were accumulated;
(5) a total number of loyalty points accumulated; and
(6) a status of said loyalty points accumulated.

67. The method of claim 65, wherein said step (J) further comprises displaying said first redemption amount with a status of "applied".

68. The method of claim 65, wherein said step (J) further comprises displaying said first redemption amount with a status of "transferred".

69. The method of claim 65, wherein said first recognized user must apply at least a minimum number of said accumulated loyalty points, and may transfer any number of said accumulated loyalty points.

70. The method of claim 65, further comprising the steps of
(K) requiring said second recognized user to provide additional registration information;
(L) categorizing a third number of said accumulated loyalty points of said second recognized user with said second status of "earned";
(M) permitting said second recognized user to selectively redeem said accumulated loyalty points having said second status in a second redemption amount no greater than said third number, wherein said second recognized user selectively redeems said accumulated loyalty points by transferring said selectively redeemed loyalty points to said first recognized user; and
wherein said step (J) further comprises displaying said second redemption amount with a status of "transfer".

71. A method of facilitating repayment of a loan obligation, said method comprising the steps of
(A) establishing a site on a global computer network;
(B) recognizing at least certain users of said site;
(C) directing said recognized users to predetermined merchants;
(D) enabling accumulation of loyalty points based upon purchases from said predetermined merchants;
(E) monitoring said purchases by said recognized users from said predetermined merchants;
(F) tracking said accumulated loyalty points; and
(G) permitting selective repayment of the loan obligation based upon discretionary redemption of said accumulated loyalty points.

72. The method of claim 71, wherein said step (A) further comprises generating an opening screen that includes a plurality of user-selectable hyperlinks.

73. The method of claim 71, wherein said step (A) further comprises generating an opening screen that includes a plurality of user-selectable icons and a corresponding plurality of user-selectable hyperlinks.

74. The method of claim 72 or 73, wherein said opening screen further includes a plurality of user-selectable sub-hyperlinks, at least one sub-hyperlink for each hyperlink.

75. The method of claim 71, wherein said step (A) further comprises generating an opening screen that includes a first plurality of user-selectable icons.

76. The method of claim 75, wherein said opening screen further includes a second plurality of user-selectable hyperlinks and a third plurality of user-selectable sub-hyperlinks, wherein said third plurality includes at least one sub-hyperlink for each hyperlink, and wherein said second plurality of hyperlinks and said third plurality of sub-hyperlinks together create a user-selectable outline of said site.

77. The method of claim 75, wherein said opening screen further includes a user-selectable menu of site content.

78. The method of claim 75, wherein said step (A) further comprises generating a site navigation system.

79. The method of claim 78, wherein said site navigation system comprises a first plurality of user-selectable icons representing site content.

80. The method of claim 78, wherein said site navigation system comprises a first plurality of user-selectable tabs representing site content.

81. The method of claim 80, wherein said site navigation system further comprises a second plurality of user-selectable sub-tabs representing site content.

82. The method of claim 78, wherein said site navigation system comprises a first plurality of user-selectable hyperlinks representing site content.

83. The method of claim 82, wherein said site navigation system further comprises a second plurality of user-selectable sub-hyperlinks representing site content.

84. The method of claim 71, wherein said step (A) further comprises establishing said site with an e-commerce component that permits purchasing from said predetermined merchants via online shopping.

85. The method of claim 84, wherein step (B) further comprises requiring said certain users to register by providing registration information.

86. The method of claim 85, wherein step (B) further comprises storing said registration information in a participant table.

87. The method of claim 85, wherein said registration information comprises
an email address;
a user name; and
a password.

88. The method of claim 87, wherein said step (B) further comprises sending a confirmatory email to said email address of said newly-registered users.

89. The method of claim 87, wherein said step (B) further comprises storing said registration information in a participant table, and enabling recognition of a returning recognized user by said stored user name and said password.
